(19) United States
(12) Patent Application Publication
(10) Pub. No.: US 2019/0087420 A1
(43) Pub. Date: Mar. 21, 2019

(54) Methods, apparatus and data structures for searching and sorting documents

(71) Applicant: Damien John Dunnington, Branchburg, NJ (US)

(72) Inventor: Damien John Dunnington, Branchburg, NJ (US)

(21) Appl. No.: 15/706,680

(22) Filed: Sep. 16, 2017

(51) Int. Cl. G06F 17/30; G06F 7/08

(52) U.S. Cl. CPC G06F 17/30011; G06F 17/3053; G06F 17/30554; G06F 7/08

(57) ABSTRACT

The methods, apparatus and data structures for searching and sorting documents disclosed herein allow users to interrogate unknown document sets at the character, page, document, context and metadata levels simultaneously in any combination. An intermediate data structure is used to store query results and can be interrogated for different results without having to re-run the search. Documents are sorted according to the patterns of keyword occurrences, such that users may identify contextual overlaps by specifying thematically distinct keyword sets.

### SUMMARY OF THE INVENTION

Existing document searching approaches take as input either a single keyword or group of terms connected by Boolean operators. This approach is insensitive to context, and can severely limit the ability to find relevant matches. To access context, a larger query set is necessary. A number of approaches to implement context-sensitive searching have been described in the prior art. Such approaches may identify documents similar to a reference item, but do not allow the user to fine tune the search to simultaneously capture customized contextual and specific information.

A first objective of this invention is to create a document search and grouping method that is easy and inexpensive to implement. A second objective of this invention is to allow the user to search unknown documents at the character, word, page, document, contextual and metadata level simultaneously in any combination. A third objective of this invention is to allow the user to group similar documents regardless of their match to a given keyword set for “more of these” searches. A fourth objective of this invention is to enable hierarchical querying such that document data are captured in the queries, which may themselves be queried in a tiered manner o uncover relationships between documents without having to repeat the search. A fifth objective of this invention is to provide a means for automated, in-depth querying of document sets for legal investigations, detection of plagiarism and “fake news”, extraction of data from forms, classification of unknown documents and performance of advanced Internet searches where the target cannot be defined by a particular keyword.

The present invention contemplates large keyword sets that may include several subsets of context-specifying items. The set shown in Table 1 relates to document searching, but could, for example, be combined with a set of financial terms. Performing the steps of the present invention will sort the financial and search-related documents, and perhaps more interestingly, the overlapping sets, into separate clusters. Moreover, because keywords are linked to actions in the present invention, the user may seek to exclude one subset from another by linking the subsets to separate attribute fields and selecting retrieval based on absence of the undesired subset. This could readily be “undone” without repeating the search.

The present invention accomplishes these objectives by linking each keyword to specific actions and the results of those actions. So, for example, if the user wishes to find documents where a specific keyword appears on Page 1 of a document and a subset of a second group of keywords appear anywhere in the document, they may associate a page capture action with the first keyword, and a document capture action with the second. On encountering a match, the linked attribute field for that keyword is modified. By scanning the page captures, the user can identify whether the document has a match to the first keyword on the first page and by counting the number of document captures and comparing it with a threshold value, the user can identify a subset match.

Having found a document of interest, the user may wish to locate similar but distinct documents. Provided that the number of keywords is sufficiently large, the pattern of matches and mismatches acts like a fingerprint of the document context. This invention provides a simple method of computing similarity scores by comparing the numbers of matches and mismatches to the total number of keywords. This feature allows the user to group similar documents together.

The use of intermediate query objects allows users to store, import, export, upload, download, and share and customize the objects themselves, without necessarily having access to the document sets used to create them. One may create consensus or divergent query objects by combining preexisting ones. Objects that are particularly effective in finding specific content may be placed in a database or on the cloud for other users to access.

### DETAILED DESCRIPTION OF THE INVENTION

As input, the present invention requires a set of keywords. While the invention may be used to find single keywords, its full benefit derives from the use of multiple keywords. Such keywords may be supplied by the user, extracted from a reference document, using word frequency dictionaries to optimize for distinctive keywords, or obtained with methods disclosed in the prior art. They may be entered manually, for example, in a tabular HTML document, imported from a delimited list, or accessed in other machine-readable formats as would be well known to one skilled in the art. In particular, the present invention contemplates importation of keyword sets and/or query objects from the results of prior searches.

Each keyword is then linked to a specific action. Table 1 shows a set of keywords generally related to this document. In one aspect of the present invention, the actions are coded numerically. In this case, 3 means set the indoc field of the query object to “true”; 1 means return the line of text surrounding the match. As described above, the actions or codes for them may be entered interactively or imported.

Once each keyword-action pair is inputted, it is imported into a data structure (herein: “query object”). In one embodiment of the present invention, the query object is a data object. Such structures are well known in the art, and may be specified as follows:

Myquery1={data: “keyword”, action: myaction, inpage: pagearray, indoc: false, docname: “”, linematches: linearray, curdoc: “”}

This structure is populated by setting myquery1.data to the first keyword and myquery1.action to the desired action. The remaining fields are left at their default values. It will be apparent to one skilled in the art that other data structures may be used in a similar manner. The above process is repeated until all of the keywords and actions have been entered into query objects, the end result being an array, myquery1, myquery2 . . . myqueryn, where n is the number of keywords.

In a preferred embodiment of the present invention the keywords are formulated as regular expressions. Regular expressions are well known in the art, and allow very precise matching at the character level. For example, the following regular expression: /\$\s*\d\S*\d{3}\S*\d{3} / will match 7 or more numeric digits preceded by a dollar sign.

Once the array of query objects is created, it can be used to search unknown documents. Preferably, and particularly in the case of documents stored in the “portable document format”, the document text is extracted using page coordinates to override linefeed characters and keep lines of text together, even when they are in tabular format. The text of each page in each unknown document is sequentially searched with keywords myquery1.data through myqueryn.data. When a match is found, the corresponding action is executed. In the case of a page-based action, the page number may be pushed to the myquery.inpage field and/or the line of text surrounding the match pushed to the myquery.linematches field. In the case of a document-based selection, the myquery.indoc field may be set to true. After searching the first unknown document, the total number of query objects with populated indoc or inpage fields may be calculated and compared with a user-defined threshold. If the count exceeds the threshold, the unknown document file name or link thereto, is copied to the curdoc field and populated query objects are copied to an output array. The query objects are then reset and the next unknown document is searched.

After all of the unknown documents have been searched, the output will comprise an array of query objects containing data for all of the documents and/or pages with matches to a subset of keywords that exceeds the user threshold. The array can then be interrogated to provide user output data. One skilled in the art will appreciate that there is great flexibility in the way data from such a search may be presented to the user. A simple example would be to list each unique file name from the curdoc field and follow it with a string of keywords obtained from the data fields for all objects containing that file name, as depicted in Table 2. More complex interactive displays are possible, such as drop-down menus to display matches at the document versus page versus line levels, charts for summary statistics, and the like.

However, a particular objective of this invention is to group similar documents together, based on keyword overlap. This may be accomplished by extracting the file names of each unknown document and their matching keywords as described above. The resulting data set is iterated in an outer loop for the “source” documents and an inner loop for the “target” documents. For each unique source-target pair, a similarity score is computed, for example, using the formula of Claim 7. The score is written to a local variable along with the target file name. As the comparison progresses, if the current score is greater than the value of the local variable, the score and file name values are overwritten, so when the comparison is complete, each source document may be associated with the most similar target document. These data may be written to additional fields in the object array.

Data from the output array may then be interrogated and sorted according to the similarity scores, as depicted in Table 3. Again, one skilled in the art will appreciate the flexibility in presentation of such data to the user, from simple lists to cluster diagrams and hyperlinks. In a further aspect of this invention, the user may store query objects from searches of interest in such a way that the query objects can be used for future document searches. One skilled in the art will appreciate that the specification described herein may be modified to achieve the same result without departing from the scope of the present invention.

### EXAMPLE

The USPTO PATFT and APPFT databases were searched with the query “Document AND search$”, resulting in 188 documents. All 188 were downloaded and searched using the method of this invention and the keywords and action codes set forth in Table 1. The raw results are tabulated in Table 2. Note that the keyword “Google” was associated with an action to search pagewise and return the line of text surrounding the match. The other queries were searched at the document level, returning true if a match was found anywhere in a document. The second column shows the number of matches in the group of 67 queries, or the document pages where “Google” is found.

It can be seen that a single search can simultaneously deliver results at the page, document, and, in the case of regular expressions such as /\btag/, at the character level. Metadata, such as the document creation date, may also be accessed (e.g. by using the doc.creationDate object in the case of pdf files).

Table 3 shows the document-level data scored using the similarity scoring procedure described herein. Clustering of similar documents is evident. It should be noted that these similarities are not general in nature (such as, for example, the trivial case that all are USPTO documents), but rather, reflect the usage of keywords within the document. This feature may be useful for detection of publications containing extremist content, which is usually aimed at an audience with stereotypical values that can be expressed by particular “buzz words”. By searching documents using keywords associated with extremist views, matching items and related documents may be flagged for editorial review.

TABLE 1
Query set for Example 1

| Keyword | Action¹ | Keyword | Action¹ |
|---|---|---|---|
| search | 3 | association | 3 |
| grouping | 3 | modify | 3 |
| plurality | 3 | import | 3 |
| keyword | 3 | export | 3 |
| operably\s*linked | 3 | frequency | 3 |
| action | 3 | dictionar | 3 |
| attribute | 3 | collection | 3 |
| document | 3 | phrase | 3 |
| execut | 3 | classify | 3 |
| field | 3 | cluster | 3 |
| data\s*structure | 3 | ranking | 3 |
| similarity\s*score | 3 | relevan | 3 |
| regular\s*expression | 3 | indirect | 3 |
| data\s*object | 3 | pointer | 3 |
| page\S*\s*based | 3 | handle | 3 |
| document\S*\s*based | 3 | Google | 1 |
| match | 3 | reference | 3 |
| threshold | 3 | identi | 3 |
| hierarchical | 3 | trigger | 3 |
| queries | 3 | extract | 3 |
| relationships | 3 | query\s*word | 3 |
| querying | 3 | render | 3 |
| classification | 3 | aggregat | 3 |
| linked | 3 | metadata | 3 |
| subset | 3 | index | 3 |
| document\s*of\s*interest | 3 | page | 3 |
| pattern | 3 | command | 3 |
| mismatch | 3 | subroutine | 3 |
| context | 3 | \btag | 3 |
| delimited | 3 | fingerprint | 3 |
| unknown\s*document | 3 | couple | 3 |
| user | 3 | element | 3 |
| overlap | 3 | array | 3 |
| adaptive | 3 | vector | 3 |

¹Action codes for this example: 1 = return the line of text surrounding the match; 3: set indoc field of the query object to true

TABLE 2
Raw output of a search of 188 patent documents related to document searching with the query set shown in Table 1.

| Target document | No. hits | Keyword matches |
|---|---|---|
| Matches in | 18 | /search/i,/plurality/i,/keyword/i,/document/i,/field/i,/match/i,/hierarchical/i,/relationships/i,/linked/i,/user/i,/pointer/i,/reference/i,/identi/i,/extract/i,/render/i,/index/i,/\btag/i,/element/i |
| US2001007987.pdf | | |
| Matches in | 13 | /search/i,/document/i,/execut/i,/field/i,/linked/i,/context/i,/dictionar/i,/reference/i,/identi/i,/page/i,/command/i,/\btag/i,/element/i |
| US2001016860.pdf | | |
| Matches in | 26 | /search/i,/plurality/i,/keyword/i,/attribute/i,/document/i,/execut/i,/field/i,/match/i,/hierarchical/i,/linked/i,/delimited/i,/user/i,/import |
| US2001020238.pdf | | /i,/frequency/i,/dictionar/i,/cluster/i,/relevan/i,/pointer/i,/reference/i,/identi/i,/extract/i,/index/i,/page/i,/command/i,/\btag/i,/element/i |
| Matches in | 29 | /search/i,/plurality/i,/action/i,/attribute/i,/document/i,/execut/i,/field/i,/match/i,/queries/i,/relationships/i,/querying/i,/pattern/i, |
| US2002002452.pdf | | /context/i,/user/i,/association/i,/frequency/i,/collection/i,/phrase/i,/ranking/i,/relevan/i,/handle/i,/reference/i,/identi/i,/extract/i,/render/i,/index/i,/page/i,/\btag/i,/element/i |
| Matches in | 22 | /search/i,/plurality/i,/keyword/i,/attribute/i,/document/i,/execut/i,/field/i,/match/i,/pattern/i,/user/i,/overlap/i,/modify/i,/import/i,/dictionar/i,/phrase/i,/reference/i,/identi/i,/ |
| US2002041713.pdf | | extract/i,/index/i,/page/i,/element/i,/vector/i |
| Matches in | 15 | /search/i,/document/i,/field/i,/match/i,/threshold/i,/user/i,/overlap/i,/import/i,/frequency/i,/phrase/i,/ranking/i,/relevan/i,/identi/i,/index/i,/element/i |
| US2002095404.pdf | | |
| Matches in | 18 | /search/i,/plurality/i,/document/i,/execut/i,/field/i,/match/i,/queries/i,/context/i,/user/i,/frequency/i,/dictionar/i,/collection/i,/relevan/i,/reference/i,/identi/i,/index/i,/page/i,/couple/i |
| US2002161570.pdf | | |
| US2003014428.pdf | page 4 | [0011] Both Google. TM, and Northern Light. TM. rely on computers and software to scan and index the Web, but |
| | page 4 | human judgment is part of the mix. At Google, Web pages that are linked from authoritative Web sites are deemed |
| Matches in | 34 | /search/i,/keyword/i,/action/i,/attribute/i,/document/i,/execut/i,/field/i,/data\s*structure/i,/match/i,/hierarchical/i,/queries/i,/relationships |
| US2003014428.pdf | | /i,/classification/i,/linked/i,/subset/i,/pattern/i,/context/i,/user/i,/import/i,/phrase/i,/cluster/i,/relevan/i,/pointer/i,/handle |
| | | /i,/reference/i,/identi/i,/trigger/i,/extract/i,/index/i,/page/i,/command/i,/\btag/i,/element/i,/vector/i |
| Matches in | 19 | /search/i,/action/i,/document/i,/execut/i,/field/i,/threshold/i,/hierarchical/i,/classification/i,/user/i,/association/i,/import/i,/frequency |
| US2003018629.pdf | | /i,/classify/i,/cluster/i,/ranking/i,/reference/i,/identi/i,/extract/i,/index/i |
| Matches in | 16 | /search/i,/document/i,/execut/i,/match/i,/queries/i,/user/i,/import/i,/frequency/i,/dictionar/i,/phrase/i,/ranking/i,/relevan/i,/reference/i,/query\s*word/i,/index/i,/command/i |
| US2003187649.pdf | | |
| Matches in | 23 | /search/i,/plurality/i,/keyword/i,/action/i,/document/i,/execut/i,/field/i,/threshold/i,/relationships/i,/classification/i,/user/i,/import |
| US2003187834.pdf | | /i,/frequency/i,/dictionar/i,/phrase/i,/relevan/i,/reference/i,/identi/i,/extract/i,/page/i,/\btag/i,/element/i,/vector/i |
| US2003220916.pdf | page 4 | [0005] In the case of major search engines available on the Internet, such as Google |
| | page 4 | (http:// www. google. com) or goo (http:// www. goo. ne. jp), when a user inputs a search request, Web |
| Matches in | 23 | /search/i,/grouping/i,/plurality/i,/keyword/i,/action/i,/document/i,/field/i,/data\s*structure/i,/threshold/i,/hierarchical/i,/user/i, |
| US2003220916.pdf | | /import/i,/frequency/i,/classify/i,/cluster/i,/relevan/i,/reference/i,/identi/i,/extract/i,/page/i,/command/i,/element/i,/vector/i |
| Matches in | 21 | /search/i,/plurality/i,/action/i,/document/i,/execut/i,/field/i,/hierarchical/i,/classification/i,/user/i,/association/i,/frequency/i,/collection |
| US2003225755.pdf | | /i,/classify/i,/cluster/i,/relevan/i,/reference/i,/identi/i,/extract/i,/page/i,/element/i,/vector/i |
| Matches in | 18 | /search/i,/plurality/i,/document/i,/execut/i,/field/i,/match/i,/queries/i,/context/i,/user/i,/frequency/i,/dictionar/i,/collection/i,/relevan/i,/reference/i,/identi/i,/index/i,/page/i,/couple/i |
| US2004006456.pdf | | |
| Matches in | 10 | /search/i,/attribute/i,/document/i,/field/i,/user/i,/frequency/i,/relevan/i,/identi/i,/page/i,/couple/i |
| US2004015779.pdf | | |
| Matches in | 20 | /search/i,/plurality/i,/action/i,/attribute/i,/document/i,/execut/i,/field/i,/data\s*structure/i,/match/i,/hierarchical/i,/pattern/i,/import |
| US2004068494.pdf | | /i,/collection/i,/classify/i,/reference/i,/identi/i,/page/i,/\btag/i,/couple/i,/element/i |
| Matches in | 32 | /search/i,/action/i,/attribute/i,/document/i,/field/i,/regular\s*expression/i,/match/i,/threshold/i,/hierarchical/i,/pattern/i,/delimited |
| US2004098389.pdf | | /i,/user/i,/overlap/i,/association/i,/import/i,/frequency/i,/phrase/i,/cluster/i,/relevan/i,/pointer/i,/handle/i,/reference/i,/identi |
| | | /i,/extract/i,/render/i,/aggregat/i,/index/i,/page/i,/fingerprint/i,/element/i,/array/i,/vector/i |
| Matches in | 27 | /search/i,/plurality/i,/action/i,/document/i,/execut/i,/field/i,/data\s*structure/i,/regular\s*expression/i,/match/i,/hierarchical/i,/ |
| US2004103090.pdf | | queries/i,/linked/i,/context/i,/user/i,/modify/i,/import/i,/frequency/i,/collection/i,/cluster/i,/ranking/i,/relevan/i,/handle/i,/reference/i,/identi/i,/render/i,/index/i,/page/i |
| US2004181520.pdf | page 4 | keyword search function, such as Google (http:// www. google. com) or goo (http:// www. goo. ne. jp), in |
| US2004181520.pdf | page 6 | such as Google (http:// www. google. com) or goo (http:// www. goo. ne. jp). |
| Matches in | 13 | /search/i,/keyword/i,/document/i,/field/i,/match/i,/user/i,/association/i,/import/i,/dictionar/i,/relevan/i,/reference/i,/identi/i,/page |
| US2004181520.pdf | | /i |
| Matches in | 17 | /search/i,/plurality/i,/action/i,/document/i,/execut/i,/match/i,/threshold/i,/user/i,/modify/i,/ranking/i,/relevan/i,/reference/i,/extract/i,/index/i,/page/i,/command/i,/vector/i |
| US2004193584.pdf | | |
| Matches in | 19 | /search/i,/grouping/i,/plurality/i,/document/i,/execut/i,/field/i,/match/i,/hierarchical/i,/linked/i,/delimited/i,/user/i,/association |
| US2004249802.pdf | | /i,/dictionar/i,/phrase/i,/reference/i,/identi/i,/index/i,/page/i,/\btag/i |
| Matches in | 23 | /search/i,/action/i,/document/i,/execut/i,/field/i,/match/i,/threshold/i,/queries/i,/classification/i,/linked/i,/context/i,/user/i,/import |
| US2004255237.pdf | | /i,/classify/i,/ranking/i,/relevan/i,/reference/i,/identi/i,/render/i,/index/i,/page/i,/couple/i,/element/i |
| Matches in | 23 | /search/i,/plurality/i,/keyword/i,/action/i,/document/i,/execut/i,/field/i,/matcht/i,/threshold/i,/pattern/i,/user/i,/import/i,/frequency |
| US2004267734.pdf | | /i,/dictionar/i,/handle/i,/reference/i,/identi/i,/extract/i,/index/i,/page/i,/command/i,/element/i,/vector/i |
| Matches in | 31 | /search/i,/grouping/i,/keyword/i,/action/i,/document/i,/match/i,/threshold/i,/queries/i,/classification/i,/subset/i,/pattern/i,/context |
| US2005102251.pdf | | /i,/user/i,/adaptive/i,/import/i,/fiequency/i,/collection/i,/phrase/i,/classify/i,/cluster/i,/ranking/i,/relevan/i,/pointer/i,/handle/i,/reference/i,/identi/i,/extract/i,/metadata/i,/index/i,/element/i,/vector/i |
| Matches in | 16 | /search/i,/plurality/i,/attribute/i,/document/i,/execut/i,/match/i,/hierarchical/i,/subset/i,/context/i,/user/i,/relevan/i,/indirect/i,/reference/i,/identi/i,/page/i,/couple/i |
| US2005210007.pdf | | |
| Matches in | 15 | /search/i,/document/i,/execut/i,/linked/i,/pattern/i,/user/i,/import/i,/phrase/i,/relevan/i,/reference/i,/identi/i,/index/i,/page/i,/command/i,/element/i |
| US2005256868.pdf | | |
| Matches in | 18 | /search/i,/plurality/i,/keyword/i,/attribute/i,/document/i,/execut/i,/field/i,/user/i,/association/i,/ranking/i,/relevan/i,/reference/i, |
| US2006031211.pdf | | /identi/i,/extract/i,/index/i,/page/i,/\btag/i,/element/i |
| Matches in | 24 | /search/i,/action/i,/document/i,/execut/i,/field/i,/match/i,/pattern/i,/context/i,/user/i,/adaptive/i,/association/i,/import/i,/collection |
| US2006039610.pdf | | /i,/phrase/i,/relevan/i,/reference/i,/identi/i,/extract/i,/index/i,/page/i,/command/i,/couple/i,/element/i,/array/i |
| Matches in | 15 | /search/i,/plurality/i,/document/i,/execut/i,/field/i,/queries/i,/linked/i,/user/i,/phrase/i,/relevan/i,/reference/i,/identi/i,/index/i,/page/i,/element/i |
| US2006069670.pdf | | |
| Matches in | 20 | /search/i,/action/i,/attribute/i,/document/i,/execut/i,/field/i,/match/i,/queries/i,/classification/i,/subset/i,/user/i,/association/i,/reference |
| US2006080295.pdf | | /i,/identi/i,/metadata/i,/subroutine/i,/\btag/i,/couple/i,/element/i,/array/i |
| Matches in | 15 | /search/i,/plurality/i,/document/i,/field/i,/match/i,/threshold/i,/association/i,/frequency/i,/dictionar/i,/reference/i,/identi/i,/extract/i,/index/i,/page/i,/array/i |
| US2006206527.pdf | | |
| Matches in | 12 | /search/i,/plurality/i,/document/i,/execut/i,/field/i,/user/i,/pointer/i,/reference/i,/identi/i,/extract/i,/index/i,/page/i |
| US2006206829.pdf | | |
| Matches in | 18 | /search/i,/keyword/i,/action/i,/attribute/i,/document/i,/execut/i,/field/i,/match/i,/queries/i,/classification/i,/user/i,/import/i,/frequency/i,/phrase/i,/ranking/i,/reference/i,/extract/i,/command/i |
| US2006230031.pdf | | |
| Matches in | 30 | /search/i,/plurality/i,/keyword/i,/action/i,/attribute/i,/document/i,/execut/i,/field/i,/data\s*structure/i,/match/i,/threshold/i,/hierarchical |
| US2007027671.pdf | | /i,/relationships/i,/document\s*of\s*interest/i,/pattern/i,/mismatch/i,/user/i,/overlap/i,/association/i,/import/i,/frequency |
| | | /i,/relevan/i,/handle/i,/reference/i,/identi/i,/extract/i,/index/i,/page/i,/\btag/i,/element/i |
| Matches in | 18 | /search/i,/plurality/i,/keyword/i,/action/i,/document/i,/execut/i,/field/i,/data\s*structure/i,/document\s*of\s*interest/i,/pattern/ |
| US2007083508.pdf | | i,/user/i,/indirect/i,/reference/i,/identi/i,/extract/i,/page/i,/command/i,/couple/i |
| Matches in | 18 | /search/i,/plurality/i,/document/i,/execut/i,/field/i,/match/i,/queries/i,/context/i,/user/i,/frequency/i,/dictionar/i,/collection/i,/relevan/i,/reference/i,/identi/i,/index/i,/page/i,/couple/i |
| US2007106500.pdf | | |
| Matches in | 26 | /search/i,/grouping/i,/plurality/i,/action/i,/document/i,/execut/i,/field/i,/match/i,/threshold/i,/queries/i,/relationships/i,/subset/i, |
| US2007198533.pdf | | /context/i,/user/i,/overlap/i,/association/i,/modify/i,/relevan/i,/indirect/i,/handle/i,/reference/i,/identi/i,/extract/i,/metadata/i,/page/i,/command/i |
| Matches in | 22 | /search/i,/plurality/i,/document/i,/execut/i,/field/i,/data\s*structure/i,/match/i,/queries/i,/querying/i,/classification/i,/linked/i,/ |
| US2007226193.pdf | | user/i,/association/i,/reference/i,/identi/i,/extract/i,/index/i,/page/i,/command/i,/subroutine/i,/element/i,/array/i |
| Matches in | 12 | /search/i,/plurality/i,/document/i,/execut/i,/field/i,/user/i,/pointer/i,/reference/i,/identi/i,/extract/i,/index/i,/page/i |
| US2007234238.pdf | | |
| US2007255686.pdf | page 12 | Google. TM. Internet search engine. |
| Matches in | 34 | /search/i,/plurality/i,/action/i,/attribute/i,/document/i,/execut/i,/field/i,/data\s*structure/i,/match/i,/hierarchical/i,/queries/i,/relationships |
| US2007255686.pdf | | /i,/linked/i,/subset/i,/pattern/i,/context/i,/delimited/i,/user/i,/association/i,/collection/i,/cluster/i,/relevan/i,/indirect/i,/pointer/i,/reference/i,/ |
| | | identi/i,/render/i,/metadata/i,/index/i,/page/i,/command/i,/\btag/i,/couple/i,/element/i |
| Matches in | 16 | /search/i,/plurality/i,/keyword/i,/document/i,/execut/i,/field/i,/match/i,/association/i,/import/i,/dictionar/i,/relevan/i,/reference/i,/identi/i,/extract/i,/page/i,/vector/i |
| US2008016065.pdf | | |
| Matches in | 10 | /search/i,/action/i,/document/i,/execut/i,/field/i,/context/i,/reference/i,/index/i,/couple/i,/element/i |
| US2008076104.pdf | | |
| Matches in | 22 | /search/i,/plurality/i,/keyword/i,/action/i,/attribute/i,/document/i,/execut/i,/field/i,/data\s*structure/i,/match/i,/hierarchical/i,/queries |
| US2008077564.pdf | | /i,/relationships/i,/user/i,/handle/i,/reference/i,/identi/i,/extract/i,/render/i,/page/i,/\btag/i,/element/i |
| Matches in | 16 | /search/i,/document/i,/execut/i,/field/i,/hierarchical/i,/queries/i,/user/i,/frequency/i,/dictionar/i,/ranking/i,/relevan/i,/reference/i,/extract/i,/index/i,/element/i,/vector/i |
| US2008082505.pdf | | |
| Matches in | 30 | /search/i,/grouping/i,/plurality/i,/keyword/i,/action/i,/attribute/i,/document/i,/execut/i,/field/i,/match/i,/hierarchical/i,/queries/ |
| US2008140657.pdf | | i,/relationships/i,/linked/i,/subset/i,/context/i,/user/i,/import/i,/frequency/i,/dictionar/i,/phrase/i,/cluster/i,/ranking/i,/relevan/i, |
| | | /reference/i,/identi/i,/trigger/i,/extract/i,/page/i,/\btag/i |
| Matches in | 20 | /search/i,/plurality/i,/attribute/i,/document/i,/execut/i,/field/i,/data\s*structure/i,/match/i,/hierarchical/i,/queries/i,/relationships |
| US2008208843.pdf | | /i,/subset/i,/user/i,/modify/i,/reference/i,/identi/i,/extract/i,/index/i,/\btag/i,/element/i |
| Matches in | 17 | /search/i,/grouping/i,/plurality/i,/document/i,/execut/i,/field/i,/hierarchical/i,/queries/i,/context/i,/user/i,/phrase/i,/relevan/i,/reference |
| US2008222112.pdf | | /i,/identi/i,/\btag/i,/couple/i,/element/i |
| Matches in | 17 | /search/i,/plurality/i,/document/i,/execut/i,/field/i,/hierarchical/i,/queries/i,/context/i,/user/i,/phrase/i,/classify/i,/relevan/i,/reference |
| US2008222141.pdf | | /identi/i,/\btag/i,/couple/i,/element/i |
| Matches in | 35 | /search/i,/grouping/i,/plurality/i,/keyword/i,/action/i,/attribute/i,/document/i,/execut/i,/field/i,/data\s*structure/i,/regular\s*expression |
| US2008263036.pdf | | /i,/match/i,/threshold/i,/classification/i,/subset/i,/pattern/i,/context/i,/user/i,/association/i,/modify/i,/import/i,/classify |
| | | /i,/cluster/i,/handle/i,/reference/i,/identi/i,/extract/i,/render/i,/index/i,/page/i,/command/i,/\btag/i,/couple/i,/array/i,/vector/i |
| Matches in | 19 | /search/i,/keyword/i,/document/i,/execut/i,/field/i,/match/i,/threshold/i,/queries/i,/pattern/i,/user/i,/modify/i,/relevan/i,/reference/i,/identi/i,/extract/i,/index/i,/page/i,/element/i,/array/i |
| US2008306919.pdf | | |
| Matches in | 17 | /search/i,/plurality/i,/action/i,/document/i,/execut/i,/field/i,/match/i,/threshold/i,/document\s*of\s*interest/i,/user/i,/import/i,/ranking |
| US2009019010.pdf | | /i,/reference/i,/identi/i,/extract/i,/page/i,/\btag/i |
| Matches in | 18 | /search/i,/keyword/i,/document/i,/execut/i,/field/i,/regular\s*expression/i,/match/i,/threshold/i,/user/i,/import/i,/dictionar/i,/collection |
| US2009055386.pdf | | /i,/ranking/i,/relevan/i,/reference/i,/identi/i,/command/i,/couple/i |
| Matches in | 23 | /search/i,/plurality/i,/keyword/i,/action/i,/document/i,/execut/i,/field/i,/match/i,/queries/i,/classification/i,/pattern/i,/context/i, |
| US2009070301.pdf | | /user/i,/import/i,/frequency/i,/relevan/i,/pointer/i,/reference/i,/identi/i,/page/i,/command/i,/\btag/i,/element/i |
| Matches in | 33 | /search/i,/grouping/i,/keyword/i,/action/i,/attribute/i,/document/i,/execut/i,/field/i,/regular\s*expression/i,/match/i,/queries/i,/ |
| US2009112841.pdf | | relationships/i,/context/i,/user/i,/overlap/i,/association/i,/import/i,/collection/i,/phrase/i,/cluster/i,/relevan/i,/indirect/i,/pointer |
| | | /i,/handle/i,/reference/i,/identi/i,/extract/i,/aggregat/i,/metadata/i,/index/i,/page/i,/\btag/i,/couple/i |
| Matches in | 17 | /search/i,/plurality/i,/document/i,/execut/i,/field/i,/data\s*structure/i,/threshold/i,/frequency/i,/dictionar/i,/collection/i,/cluster |
| US2009119343.pdf | | /i,/relevan/i,/reference/i,/index/i,/page/i,/element/i,/vector/i |
| Matches in | 38 | /search/i,/plurality/i,/keyword/i,/action/i,/attribute/i,/document/i,/execut/i,/data\s*structure/i,/match/i,/threshold/i,/queries/i,/relationships |
| US2009171938.pdf | | /i,/classification/i,/linked/i,/subset/i,/pattern/i,/context/i,/user/i,/association/i,/import/i,/frequency/i,/phrase/i,/classify |
| | | /i,/ranking/i,/relevan/i,/reference/i,/identi/i,/trigger/i,/render/i,/aggregat/i,/metadata/i,/index/i,/page/i,/command/i,/\btag/i,/couple/i,/element/i,/vector/i |
| Matches in | 18 | /search/i,/grouping/i,/plurality/i,/keyword/i,/attribute/i,/document/i,/execut/i,/field/i,/match/i,/relationships/i,/user/i,/frequency |
| US2009183115.pdf | | /i,/relevan/i,/reference/i,/identi/i,/extract/i,/page/i,/element/i |
| Matches in | 23 | /search/i,/keyword/i,/action/i,/document/i,/field/i,/match/i,/threshold/i,/classification/i,/subset/i,/context/i,/user/i,/import/i,/collection |
| US2009187797.pdf | | /i,/phrase/i,/classify/i,/relevan/i,/reference/i,/identi/i,/extract/i,/aggregat/i,/metadata/i,/index/i,/page/i |
| Matches in | 18 | /search/i,/plurality/i,/keyword/i,/document/i,/execut/i,/field/i,/user/i,/import/i,/frequency/i,/collection/i,/phrase/i,/relevan/i,/reference/i,/identi/i,/index/i,/page/i,/\btag/i,/element/i |
| US2009319510.2df | | |
| Matches in | 21 | /search/i,/plurality/i,/action/i,/attribute/i,/document/i,/execut/i,/field/i,/data\s*structure/i,/hierarchical/i,/user/i,/import/i,/relevan |
| US2010010970.pdf | | /i,/handle/i,/reference/i,/identi/i,/extract/i,/metadata/i,/index/i,/command/i,/\btag/i,/element/i |
| Matches in | 24 | /search/i,/plurality/i,/keyword/i,/action/i,/document/i,/field/i,/data\s*structure/i,/match/i,/context/i,/user/i,/association/i,/import |
| US2010049705.pdf | | /i,/frequency/i,/dictionar/i,/collection/i,/phrase/i,/relevan/i,/reference/i,/identi/i,/extract/i,/render/i,/index/i,/\btag/i,/element/i |
| Matches in | 21 | /search/i,/plurality/i,/keyword/i,/action/i,/document/i,/field/i,/data\s*structure/i,/match/i,/threshold/i,/linked/i,/user/i,/association |
| US2010076999.pdf | | /i,/dictionar/i,/phrase/i,/pointer/i,/reference/i,/identi/i,/extract/i,/index/i,/page/i,/element/i |
| Matches in | 20 | /search/i,/plurality/i,/action/i,/attribute/i,/document/i,/execut/i,/field/i,/data\s*structure/i,/match/i,/hierarchical/i,/user/i,/import |
| US2010100544.pdf | | /i,/relevan/i,/handle/i,/reference/i,/identi/i,/extract/i,/index/i,/\btag/i,/element/i |
| Matches in | 13 | /search/i,/plurality/i,/keyword/i,/document/i,/execut/i,/field/i,/user/i,/import/i,/phrase/i,/relevan/i,/identi/i,/extract/i,/page/i |
| US2010196295.pdf | | |
| Matches in | 36 | /search/i,/plurality/i,/keyword/i,/action/i,/attribute/i,/document/i,/execut/i,/field/i,/data\s*structure/i,/data\s*object/i,/match/i,/ |
| US2010198816.pdf | | threshold/i,/hierarchical/i,/queries/i,/relationships/i,/classification/i,/linked/i,/context/i,/user/i,/association/i,/import/i,/dictionar |
| | | /i,/phrase/i,/classify/i,/relevan/i,/pointer/i,/reference/i,/identi/i,/render/i,/metadata/i,/index/i,/page/i,/\btag/i,/couple/i,/element/i,/vector/i |
| Matches in | 22 | /search/i,/plurality/i,/document/i,/execut/i,/field/i,/match/i,/queries/i,/classification/i,/subset/i,/context/i,/user/i,/modify/i,/frequency/i,/collection/i,/ranking/i,/ |
| US2010228743.pdf | | relevan/i,/reference/i,/identi/i,/extract/i,/aggregat/i,/page/i,/vector/i |
| US201025716.pdf | page 13 | Google. TM. Internet search engine. |
| Matches in | 35 | /search/i,/plurality/i,/action/i,/attribute/i,/document/i,/execut/i,/field/i,/data\s*structure/i,/match/i,/hierarchical/i,/queries/i,/relationships |
| US2010257161.pdf | | /i,/linked/i,/subset/i,/pattern/i,/context/i,/delimited/i,/user/i,/association/i,/collection/i,/cluster/i,/ranking/i,/relevan/i, |
| | | /indirect/i,/pointer/i,/reference/i,/identi/i,/render/i,/metadata/i,/index/i,/page/i,/command/i,/\btag/i,/couple/i,/element/i |
| Matches in | 24 | /search/i,/plurality/i,/keyword/i,/action/i,/document/i,/execut/i,/field/i,/hierarchical/i,/queries/i,/linked/i,/user/i,/association/i,/ |
| US2010287272.pdf | | collection/i,/phrase/i,/relevan/i,/reference/i,/identi/i,/extract/i,/index/i,/page/i,/couple/i,/element/i,/array/i,/vector/i |
| Matches in | 24 | /search/i,/action/i,/document/i,/execut/i,/field/i,/match/i,/pattern/i,/context/i,/user/i,/adaptive/i,/association/i,/import/i,/collection/i,/phrase/i,/relevan/i,/reference/ |
| US2011019917.pdf | | i,/identi/i,/extract/i,/index/i,/page/i,/command/i,/couple/i,/element/i,/array/i |
| US2011029518.pdf | page 1 | Assignee: GOOGLE INC. |
| Matches in | 23 | /search/i,/action/i,/document/i,/execut/i,/field/i,/match/i,/threshold/i,/queries/i,/classification/i,/linked/i,/context/i,/user/i,/import |
| US2011029518.pdf | | /i,/classify/i,/ranking/i,/relevan/i,/reference/i,/identi/i,/render/i,/index/i,/page/i,/couple/i,/element/i |
| Matches in | 24 | /search/i,/plurality/i,/keyword/i,/attribute/i,/document/i,/execut/i,/field/i,/data\s*structure/i,/match/i,/queries/i,/linked/i,/user/i,/overlap/i,/association/i,/import/ |
| US011082878.pdf | | i,/frequency/i,/dictionar/i,/relevan/i,/reference/i,/extract/i,/index/i,/page/i,/element/i,/vector/i |
| Matches in | 12 | /search/i,/plurality/i,/keyword/i,/document/i,/execut/i,/field/i,/user/i,/relevan/i,/reference/i,/index/i,/page/i,/command/i |
| US2011167062.pdf | | |
| Matches in | 27 | /search/i,/document/i,/execut/i,/field/i,/data\s*structure/i,/match/i,/queries/i,/linked/i,/pattern/i,/mismatch/i,/context/i,/user/i,/ |
| US2011231394.pdf | | adaptive/i,/frequency/i,/collection/i,/classify/i,/ranking/i,/relevan/i,/reference/i,/identi/i,/metadata/i,/index/i,/page/i,/\btag/i,/couple |
| | | /i,/element/i,/vector/i |
| Matches in | 26 | /search/i,/grouping/i,/plurality/i,/action/i,/document/i,/execut/i,/field/i,/match/i,/threshold/i,/queries/i,/relationships/i,/subset/i, |
| US2011264995.pdf | | /context/i,/user/i,/overlap/i,/association/i,/modify/i,/relevan/i,/indirect/i,/handle/i,/reference/i,/identi/i,/extract/i,/metadata/i,/ |
| | | page/i,/command/i |
| Matches in | 18 | /search/i,/plurality/i,/keyword/i,/document/i,/execut/i,/field/i,/linked/i,/user/i,/dictionar/i,/handle/i,/reference/i,/identi/i,/extract/i,/metadata/i,/index/i,/page/i,/\btag/i,/element/i |
| US2012023133.pdf | | |
| Matches in | 20 | /search/i,/plurality/i,/keyword/i,/action/i,/document/i,/execut/i,/data\s*structure/i,/match/i,/queries/i,/subset/i,/user/i,/modify/ |
| US2012110015.pdf | | i,/reference/i,/identi/i,/metadata/i,/index/i,/page/i,/command/i,/\btag/i,/element/i |
| Matches in | 18 | /search/i,/plurality/i,/keyword/i,/document/i,/execut/i,/field/i,/user/i,/import/i,/frequency/i,/collection/i,/phrase/i,/relevan/i,/reference |
| US2012150866.pdf | | /i,/identi/i,/index/i,/page/i,/\btag/i,/element/i |
| Matches in | 22 | /search/i,/plurality/i,/action/i,/document/i,/execut/i,/field/i,/queries/i,/relationships/i,/pattern/i,/context/i,/user/i,/overlap/i,/import/i,/cluster/i,/relevan/i,/pointer/i,/ |
| US2012221553.pdf | | reference/i,/identi/i,/metadata/i,/index/i,/page/i,/couple/i |
| Matches in | 19 | /search/i,/plurality/i,/keyword/i,/document/i,/execut/i,/field/i,/threshold/i,/classification/i,/linked/i,/user/i,/association/i,/import |
| US2012239654.pdf | | /i,/collection/i,/relevan/i,/indirect/i,/reference/i,/extract/i,/page/i,/vector/i |
| Matches in | 19 | /search/i,/plurality/i,/document/i,/execut/i,/field/i,/match/i,/queries/i,/subset/i,/context/i,/user/i,/import/i,/frequency/i,/collection |
| US2012254161.pdf | | /i,/phrase/i,/relevan/i,/reference/i,/extract/i,/render/i,/index/i |
| Matches in | 22 | /search/i,/plurality/i,/action/i,/attribute/i,/document/i,/execut/i,/field/i,/match/i,/hierarchical/i,/linked/i,/delimited/i,/user/i,/association/i,/phrase/i,/relevan/i,/reference/i,/ |
| US2013117306.pdf | | identi/i,/index/i,/page/i,/\btag/i,/couple/i,/element/i |
| Matches in | 27 | /search/i,/plurality/i,/keyword/i,/action/i,/document/i,/execut/i,/field/i,/classification/i,/linked/i,/pattern/i,/context/i,/user/i,/modify |
| US2013124515.pdf | | /i,/import/i,/frequency/i,/dictionar/i,/collection/i,/phrase/i,/relevan/i,/reference/i,/identi/i,/extract/i,/metadata/i,/page/i,/\btag |
| | | /i,/element/i,/vector/i |
| US2013185287.pdf | page 1 | Google Inc.; Mountain View CA US |
| | page 1 | Assignee: Google Inc. |
| Matches in | 15 | /search/i,/plurality/i,/document/i,/execut/i,/field/i,/queries/i,/linked/i,/user/i,/phrase/i,/relevan/i,/reference/i,/identi/i,/index/i,/page/i,/element/i |
| US2013185287.pdf | | |
| Matches in | 17 | /search/i,/action/i,/document/i,/execut/i,/field/i,/match/i,/threshold/i,/document\s*of\s*interest/i,/user/i,/import/i,/ranking/i,/reference/i,/identi/i,/extract/i,/render/i,/page/i,/\btag/i |
| US2013226917.pdf | | |
| Matches in | 18 | /search/i,/plurality/i,/keyword/i,/document/i,/execut/i,/field/i,/hierarchical/i,/context/i,/user/i,/import/i,/dictionar/i,/relevan/i,/ |
| US2013268554.pdf | | reference/i,/identi/i,/extract/i,/page/i,/\btag/i,/element/i |
| Matches in | 24 | /search/i,/plurality/i,/keyword/i,/action/i,/document/i,/execut/i,/field/i,/match/i,/threshold/i,/queries/i,/subset/i,/user/i,/frequency/i,/ranking/i,/relevan/i,/pointer/ |
| US2013275420.pdf | | i,/handle/i,/reference/i,/identi/i,/metadata/i,/index/i,/page/i,/\btag/i,/couple/i |
| Matches in | 13 | /search/i,/plurality/i,/document/i,/execut/i,/field/i,/match/i,/delimited/i,/user/i,/overlap/i,/handle/i,/reference/i,/page/i,/vector/i |
| US2013301921.pdf | | |
| Matches in | 20 | /search/i,/plurality/i,/action/i,/document/i,/execut/i,/field/i,/data\s*structure/i,/match/i,/threshold/i,/queries/i,/pattern/i,/context |
| US2013318120.pdf | | /i,/user/i,/overlap/i,/modify/i,/indirect/i,/reference/i,/extract/i,/page/i,/vector/i |
| Matches in | 23 | /search/i,/keyword/i,/document/i,/execut/i,/field/i,/match/i,/context/i,/user/i,/frequency/i,/collection/i,/phrase/i,/ranking/i,/relevan |
| US2014006390.pdf | | /i,/reference/i,/identi/i,/render/i,/metadata/i,/page/i,/command/i,/\btag/i,/couple/i,/element/i,/array/i |
| Matches in | 23 | /search/i,/keyword/i,/document/i,/execut/i,/field/i,/match/i,/context/i,/user/i,/frequency/i,/collection/i,/phrase/i,/ranking/i,/relevan/i,/reference/i,/identi/i,/render/i,/ |
| US2014006419.pdf | | metadata/i,/page/i,/command/i,/\btag/i,/couple/i,/element/i,/array/i |
| Matches in | 23 | /search/i,/plurality/i,/attribute/i,/document/i,/execut/i,/field/i,/data\s*structure/i,/context/i,/user/i,/overlap/i,/import/i,/frequency |
| US2014032567.pdf | | /i,/collection/i,/cluster/i,/ranking/i,/relevan/i,/reference/i,/identi/i,/extract/i,/metadata/i,/index/i,/page/i,/vector/i |
| Matches in | 13 | /search/i,/plurality/i,/keyword/i,/action/i,/document/i,/execut/i,/pattern/i,/user/i,/overlap/i,/reference/i,/identi/i,/extract/i,/page |
| US2014063564.pdf | | /i |
| Matches in | 14 | /search/i,/plurality/i,/document/i,/execut/i,/field/i,/threshold/i,/pattern/i,/user/i,/overlap/i,/dictionar/i,/handle/i,/reference/i,/identi |
| US2014072225.pdf | | /i,/page/i |
| Matches in | 28 | /search/i,/plurality/i,/document/i,/execut/i,/field/i,/data\s*structure/i,/threshold/i,/hierarchical/i,/relationships/i,/classification/ |
| US2014101171.pdf | | i,/context/i,/user/i,/import/i,/frequency/i,/dictionar/i,/collection/i,/phrase/i,/classify/i,/cluster/i,/reference/i,/identi/i,/extract/i,/index/i,/page/i,/couple/i,/element/i,/array/i,/vector/i |
| Matches in | 14 | /search/i,/plurality/i,/keyword/i,/document/i,/execut/i,/field/i,/user/i,/import/i,/phrase/i,/relevan/i,/reference/i,/identi/i,/extract |
| US2014229505.pdf | | /i,/page/i |
| Matches in | 29 | /search/i,/plurality/i,/action/i,/attribute/i,/document/i,/execut/i,/field/i,/data\s*structure/i,/queries/i,/relationships/i,/subset/i,/context |
| US2014236986.pdf | | /i,/user/i,/association/i,/import/i,/frequency/i,/dictionar/i,/phrase/i,/relevan/i,/indirect/i,/reference/i,/identi/i,/metadata/i,/index/i,/page/i,/command/i,/couple/i,/element/i,/array/i |
| Matches in | 28 | /search/i,/plurality/i,/keyword/i,/action/i,/attribute/i,/document/i,/execut/i,/field/i,/data\s*structure/i,/match/i,/threshold/i,/queries |
| US2014280082.pdf | | /i,/classification/i,/subset/i,/user/i,/frequency/i,/dictionar/i,/phrase/i,/ranking/i,/relevan/i,/reference/i,/identi/i,/extract/i,/render/i,/couple/i,/element/i,/array/i,/vector/i |
| Matches in | 27 | /search/i,/keyword/i,/action/i,/document/i,/execut/i,/field/i,/match/i,/subset/i,/pattern/i,/context/i,/user/i,/overlap/i,/import/i,/frequency |
| US2015010235.pdf | | /i,/phrase/i,/relevan/i,/reference/i,/identi/i,/extract/i,/render/i,/index/i,/page/i,/\btag/i,/fingerprint/i,/couple/i,/element |
| | | /i,/array/i |
| Matches in | 14 | /search/i,/plurality/i,/document/i,/execut/i,/field/i,/threshold/i,/user/i,/phrase/i,/cluster/i,/reference/i,/identi/i,/extract/i,/page/i, |
| US2015095314.pdf | | /element/i |
| Matches in | 22 | /search/i,/plurality/i,/keyword/i,/action/i,/document/i,/execut/i,/field/i,/data\s*structure/i,/match/i,/threshold/i,/hierarchical/i,/ |
| US2015112693.pdf | | user/i,/association/i,/import/i,/frequency/i,/handle/i,/reference/i,/identi/i,/extract/i,/index/i,/page/i,/vector/i |
| Matches in | 28 | /search/i,/plurality/i,/keyword/i,/action/i,/document/i,/execut/i,/field/i,/data\s*structure/i,/threshold/i,/subset/i,/pattern/i,/user/ |
| US2015213012.pdf | | i,/import/i,/frequency/i,/phrase/i,/cluster/i,/ranking/i,/relevan/i,/indirect/i,/reference/i,/identi/i,/extract/i,/metadata/i,/index/i,/page/i,/\btag/i,/couple/i,/element/i |
| Matches in | 19 | /search/i,/plurality/i,/document/i,/execut/i,/field/i,/match/i,/queries/i,/subset/i,/context/i,/user/i,/import/i,/frequency/i,/collection/i,/phrase/i,/relevan/i,/reference/ |
| US2015294017.pdf | | i,/extract/i,/render/i,/index/i |
| Matches in | 14 | /search/i,/document/i,/execut/i,/field/i,/data\s*structure/i,/match/i,/threshold/i,/user/i,/adaptive/i,/handle/i,/reference/i,/identi/ |
| US2015347835.pdf | | i,/index/i,/page/i |
| Matches in | 27 | /search/i,/keyword/i,/action/i,/document/i,/execut/i,/field/i,/match/i,/subset/i,/pattern/i,/context/i,/user/i,/overlap/i,/import/i,/frequency |
| US2016232228.pdf | | /i,/phrase/i,/relevan/i,/reference/i,/identi/i,/extract/i,/render/i,/index/i,/page/i,/\btag/i,/fingerprint/i,/couple/i,/element |
| | | /i,/array/i |
| Matches in | 24 | /search/i,/plurality/i,/action/i,/document/i,/execut/i,/field/i,/match/i,/threshold/i,/queries/i,/relationships/i,/subset/i,/user/i,/overlap |
| US2016246851.pdf | | /i,/association/i,/import/i,/frequency/i,/dictionar/i,/relevan/i,/reference/i,/extract/i,/index/i,/page/i,/element/i,/vector/i |
| Matches in | 30 | /search/i,/plurality/i,/keyword/i,/action/i,/attribute/i,/document/i,/execut/i,/field/i,/data\s*structure/i,/match/i,/threshold/i,/queries |
| US2016350315.pdf | | /i,/relationships/i,/linked/i,/subset/i,/context/i,/user/i,/phrase/i,/ranking/i,/relevan/i,/pointer/i,/reference/i,/identi/i,/extract/i,/render/i,/aggregat/i,/metadata/i,/ |
| | | index/i,/page/i,/\btag/i |
| Matches in | 22 | /search/i,/plurality/i,/action/i,/attribute/i,/document/i,/execut/i,/field/i,/match/i,/hierarchical/i,/linked/i,/delimited/i,/user/i,/association |
| US2017004186.pdf | | /i,/phrase/i,/relevan/i,/reference/i,/identi/i,/index/i,/page/i,/\btag/i,/couple/i,/element/i |
| US2017046446.pdf | page 1 | Google Inc. Mountain View CA US |
| Matches in | 16 | /search/i,/plurality/i,/action/i,/document/i,/execut/i,/field/i,/queries/i,/linked/i,/user/i,/phrase/i,/relevan/i,/reference/i,/identi/i,/index/i,/page/i,/element/i |
| US2017046446.pdf | | |
| Matches in | 27 | /search/i,/keyword/i,/action/i,/document/i,/execut/i,/field/i,/match/i,/subset/i,/pattern/i,/context/i,/user/i,/overlap/i,/import/i,/frequency |
| US2017109375.pdf | | /i,/phrase/i,/relevan/i,/reference/i,/identi/i,/extract/i,/render/i,/index/i,/page/i,/\btag/i,/fingerprint/i,/couple/i,/element |
| | | /i,/array/i |
| Matches in | 26 | /search/i,/plurality/i,/action/i,/document/i,/execut/i,/field/i,/data\s*structure/i,/match/i,/threshold/i,/linked/i,/context/i,/user/i,/ |
| US2017132730.pdf | | association/i,/import/i,/frequency/i,/phrase/i,/ranking/i,/indirect/i,/handle/i,/reference/i,/identi/i,/page/i,/couple/i,/element/i,/array |
| | | /i,/vector/i |
| Matches in | 20 | /search/i,/plurality/i,/keyword/i,/action/i,/attribute/i,/document/i,/execut/i,/field/i,/match/i,/user/i,/association/i,/dictionar/i,/phrase/i,/handle/i,/reference/i,/extract/i,/ |
| US2017140037.pdf | | query\s*word/i,/page/i,/\btag/i,/element/i |
| Matches in | 22 | /search/i,/plurality/i,/attribute/i,/document/i,/execut/i,/field/i,/data\s*structure/i,/match/i,/hierarchical/i,/relationships/i,/linked |
| US5628008.pdf | | /i,/pattern/i,/context/i,/user/i,/overlap/i,/modify/i,/relevan/i,/pointer/i,/reference/i,/identi/i,/extract/i,/page/i |
| Matches in | 25 | /search/i,/plurality/i,/action/i,/document/i,/execut/i,/field/i,/match/i,/threshold/i,/hierarchical/i,/queries/i,/pattern/i,/context/i,/ |
| US5748953.pdf | | user/i,/import/i,/frequency/i,/dictionar/i,/relevan/i,/pointer/i,/reference/i,/identi/i,/extract/i,/index/i,/page/i,/command/i,/element |
| | | /i |
| Matches in | 29 | /search/i,/plurality/i,/keyword/i,/action/i,/document/i,/field/i,/data\s*structure/i,/match/i,/queries/i,/classification/i,/subset/i,/document |
| US5832474.pdf | | \s*of\s*interest/i,/pattern/i,/user/i,/association/i,/import/i,/cluster/i,/ranking/i,/relevan/i,/pointer/i,/handle/i,/reference |
| | | /i,/identi/i,/extract/i,/render/i,/index/i,/page/i,/couple/i,/vector/i |
| Matches in | 18 | /search/i,/plurality/i,/action/i,/document/i,/execut/i,/field/i,/classification/i,/linked/i,/user/i,/classify/i,/indirect/i,/reference/i,/identi/i,/extract/i,/page/i,/command/i,/\btag/i,/element/i |
| US5832476.pdf | | |
| Matches in | 14 | /search/i,/keyword/i,/document/i,/execut/i,/field/i,/linked/i,/context/i,/dictionar/i,/reference/i,/identi/i,/page/i,/command/i,/\btag |
| US5956740.pdf | | /i,/element/i |
| Matches in | 32 | /search/i,/plurality/i,/keyword/i,/action/i,/document/i,/execut/i,/field/i,/match/i,/hierarchical/i,/queries/i,/relationships/i,/linked |
| US5983221.pdf | | /i,/subset/i,/context/i,/user/i,/modify/i,/import/i,/frequency/i,/phrase/i,/cluster/i,/ranking/i,/relevan/i,/handle/i,/reference/i,/identi |
| | | /i,/extract/i,/query\s*word/i,/render/i,/index/i,/page/i,/command/i,/element/i |
| Matches in | 27 | /search/i,/plurality/i,/action/i,/document/i,/execut/i,/field/i,/match/i,/hierarchical/i,/relationships/i,/classification/i,/pattern/i,/ |
| US6094647.pdf | | mismatch/i,/context/i,/user/i,/overlap/i,/import/i,/frequency/i,/dictionar/i,/collection/i,/phrase/i,/pointer/i,/reference/i,/identi/i,/extract/i,/index/i,/page/i,/command/i |
| Matches in | 14 | /search/i,/keyword/i,/document/i,/execut/i,/field/i,/linked/i,/context/i,/dictionar/i,/reference/i,/identi/i,/page/i,/command/i,/\btag |
| US6212537.pdf | | /i,/element/i |
| Matches in | 15 | /search/i,/plurality/i,/keyword/i,/document/i,/execut/i,/field/i,/match/i,/user/i,/ranking/i,/reference/i,/identi/i,/index/i,/page/i,/ |
| US6298344.pdf | | command/i,/element/i |
| Matches in | 13 | /search/i,/document/i,/execut/i,/field/i,/linked/i,/context/i,/dictionar/i,/reference/i,/identi/i,/page/i,/command/i,/\btag/i,/element |
| US6356894.pdf | | /i |
| Matches in | 21 | /search/i,/plurality/i,/action/i,/attribute/i,/document/i,/execut/i,/field/i,/data\s*structure/i,/hierarchical/i,/pattern/i,/context/i,/user |
| US6377946.pdf | | /i,/pointer/i,/reference/i,/identi/i,/extract/i,/index/i,/page/i,/command/i,/\btag/i,/element/i |
| Matches in | 18 | /search/i,/plurality/i,/document/i,/execut/i,/field/i,/match/i,/queries/i,/context/i,/user/i,/frequency/i,/dictionar/i,/collection/i,/relevan/i,/reference/i,/identi/i,/index/i,/page/i,/couple/i |
| US6466901.pdf | | |
| Matches in | 22 | /search/i,/plurality/i,/keyword/i,/action/i,/document/i,/execut/i,/field/i,/data\s*structure/i,/match/i,/threshold/i,/user/i,/dictionar |
| US6470336.pdf | | /i,/collection/i,/phrase/i,/reference/i,/identi/i,/extract/i,/index/i,/page/i,/fingerprint/i,/element/i,/vector/i |
| Matches in | 22 | /search/i,/plurality/i,/keyword/i,/action/i,/document/i,/execut/i,/field/i,/threshold/i,/delimited/i,/user/i,/import/i,/frequency/i,/ |
| US6473754.pdf | | dictionar/i,/ranking/i,/relevan/i,/reference/i,/identi/i,/extract/i,/index/i,/page/i,/command/i,/vector/i |
| Matches in | 21 | /search/i,/plurality/i,/attribute/i,/document/i,/execut/i,/field/i,/data\s*structure/i,/match/i,/hierarchical/i,/pattern/i,/context/i,/user |
| US6510425.pdf | | /i,/pointer/i,/reference/i,/identi/i,/extract/i,/index/i,/page/i,/command/i,/\btag/i,/element/i |
| Matches in | 16 | /search/i,/keyword/i,/action/i,/document/i,/field/i,/match/i,/threshold/i,/queries/i,/context/i,/user/i,/phrase/i,/relevan/i,/reference/i,/identi/i,/extract/i,/page/i |
| US6618722.pdf | | |
| Matches in | 19 | /search/i,/plurality/i,/document/i,/execut/i,/field/i,/match/i,/queries/i,/context/i,/user/i,/frequency/i,/dictionar/i,/collection/i,/ranking |
| US6654717.pdf | | /i,/relevan/i,/reference/i,/identi/i,/index/i,/page/i,/couple/i |
| Matches in | 18 | /search/i,/plurality/i,/document/i,/field/i,/match/i,/threshold/i,/user/i,/overlap/i,/import/i,/frequency/i,/phrase/i,/ranking/i,/relevan |
| US6718323.pdf | | /i,/reference/i,/identi/i,/index/i,/page/i,/element/i |
| Matches in | 26 | /search/i,/grouping/i,/keyword/i,/attribute/i,/document/i,/execut/i,/field/i,/match/i,/threshold/i,/hierarchical/i,/relationships/i,/ |
| US6718333.pdf | | classification/i,/linked/i,/context/i,/user/i,/association/i,/collection/i,/phrase/i,/classify/i,/relevan/i,/reference/i,/identi/i,/extract/i,/index/i,/page/i,/\btag/i |
| Matches in | 19 | /search/i,/plurality/i,/keyword/i,/document/i,/field/i,/match/i,/hierarchical/i,/relationships/i,/linked/i,/user/i,/pointer/i,/reference |
| US6853992.pdf | | /i,/identi/i,/extract/i,/render/i,/index/i,/page/i,/\btag/i,/element/i |
| Matches in | 23 | /search/i,/plurality/i,/keyword/i,/action/i,/attribute/i,/document/i,/execut/i,/field/i,/match/i,/pattern/i,/user/i,/overlap/i,/modify/i,/import/i,/dictionar/i,/phrase/i,/ |
| US6944344.pdf | | reference/i,/identi/i,/extract/i,/index/i,/page/i,/element/i,/vector/i |
| US7047255.pdf | page 4 | In the case of major search engines available on the Internet, such as Google |
| | page 4 | (http:// www. google. com) or goo (http:// www. goo. ne. jp), when a user inputs a search request, Web |
| Matches in | 23 | /search/i,/grouping/i,/plurality/i,/keyword/i,/action/i,/document/i,/field/i,/data\s*structure/i,/threshold/i,/hierarchical/i,/user/i, |
| US7047255.pdf | | /import/i,/frequency/i,/classify/i,/cluster/i,/relevan/i,/reference/i,/identi/i,/extract/i,/page/i,/command/i,/element/i,/vector/i |
| Matches in | 23 | /search/i,/plurality/i,/keyword/i,/action/i,/attribute/i,/document/i,/execut/i,/field/i,/match/i,/hierarchical/i,/classification/i,/linked |
| US7054854.pdf | | /i,/pattern/i,/user/i,/phrase/i,/classify/i,/reference/i,/extract/i,/index/i,/page/i,/command/i,/\btag/i,/element/i |
| Matches in | 21 | /search/i,/document/i,/execut/i,/field/i,/match/i,/queries/i,/classification/i,/user/i,/import/i,/frequency/i,/dictionar/i,/phrase/i,/cluster |
| US7089188.pdf | | /i,/ranking/i,/relevan/i,/reference/i,/identi/i,/query\s*word/i,/index/i,/page/i,/command/i |
| Matches in | 19 | /search/i,/plurality/i,/document/i,/execut/i,/field/i,/match/i,/queries/i,/context/i,/user/i,/frequency/i,/dictionar/i,/collection/i,/ranking/i,/relevan/i,/reference/i,/identi/i,/ |
| US7174290.pdf | | index/i,/page/i,/couple/i |
| US7185001.pdf | page 12 | part, utilize commercially available search engine (e.g., Google. TM., Alta Vista, RTM., |
| US7185001.pdf | page 13 | search engines (e.g., Google. TM., Alta Vista. RTM., Excite. sup. SM, Lycos. RTM., etc.) to perform a |
| Matches in | 34 | /search/i,/grouping/i,/plurality/i,/keyword/i,/action/i,/document/i,/field/i,/data\s*structure/i,/similarity\s*score/i,/match/i,/threshold |
| US7185001.pdf | | /i,/hierarchical/i,/queries/i,/classification/i,/user/i,/overlap/i,/association/i,/modify/i,/import/i,/frequency/i,/collection/i,/ |
| | | phrase/i,/classify/i,/cluster/i,/ranking/i,/relevan/i,/reference/i,/identi/i,/extract/i,/index/i,/page/i,/\btag/i,/element/i,/vector/i |
| Matches in | 26 | /search/i,/plurality/i,/keyword/i,/attribute/i,/document/i,/execut/i,/field/i,/match/i,/hierarchical/i,/linked/i,/delimited/i,/user/i,/import |
| US7225181.pdf | | /i,/frequency/i,/dictionar/i,/cluster/i,/relevan/i,/pointer/i,/reference/i,/identi/i,/extract/i,/index/i,/page/i,/command/i,/\btag |
| | | /i,/element/i |
| US7240051.pdf | page 5 | keyword search function, such as Google (http:// www. google. com) or goo (http:// www. goo. ne. jp), in |
| US7240051.pdf | page 7 | Google (http:// www. google. com) or goo (http:// www. goo. ne. jp). |
| Matches in | 16 | /search/i,/plurality/i,/keyword/i,/document/i,/field/i,/match/i,/linked/i,/user/i,/association/i,/import/i,/dictionar/i,/relevan/i,/reference |
| US7240051.pdf | | /i,/identi/i,/extract/i,/page/i |
| Matches in | 17 | /search/i,/plurality/i,/attribute/i,/document/i,/execut/i,/field/i,/match/i,/hierarchical/i,/subset/i,/context/i,/user/i,/relevan/i,/indirect/i,/reference/identi/i,/page/i,/couple/i |
| US7324998.pdf | | |
| Matches in | 22 | /search/i,/keyword/i,/action/i,/document/i,/execut/i,/field/i,/threshold/i,/hierarchical/i,/classification/i,/user/i,/association/i,/import |
| US7349899.pdf | | /i,/frequency/i,/collection/i,/classify/i,/cluster/i,/ranking/i,/reference/i,/identi/i,/extract/i,/index/i,/page/i |
| Matches in | 18 | /search/i,/plurality/i,/document/i,/execut/i,/field/i,/match/i,/queries/i,/context/i,/user/i,/frequency/i,/dictionar/i,/collection/i,/relevan |
| US7369987.pdf | | /i,/reference/i,/identi/i,/index/i,/page/i,/couple/i |
| Matches in | 18 | /search/i,/plurality/i,/keyword/i,/attribute/i,/document/i,/execut/i,/field/i,/user/i,/association/i,/ranking/i,/relevan/i,/reference/i,/identi/i,/extract/i,/index/i,/page/i,/\btag/i,/element/i |
| US7401078.pdf | | |
| Matches in | 21 | /search/i,/plurality/i,/action/i,/attribute/i,/document/i,/execut/i,/field/i,/data\s*structure/i,/match/i,/hierarchical/i,/pattern/i,/import |
| US7509305.pdf | | /i,/collection/i,/classify/i,/reference/i,/identi/i,/index/i,/page/i,/\btag/i,/couple/i,/element/i |
| US7584179.pdf | page 3 | as Google. com or Ask. com. A user is first asked to input search terms in response to which the |
| US7584179.pdf | page 4 | by the program's estimate of the relevance of each URL. In the case of Google. com, the ranking is |
| Matches in | 21 | /search/i,/document/i,/execut/i,/field/i,/data\s*structure/i,/queries/i,/contex/i,/user/i,/overlap/i,/association/i,/modify/i,/import |
| US7584179.pdf | | /i,/phrase/i,/ranking/i,/relevan/i,/pointer/i,/reference/i,/identi/i,/render/i,/index/i,/page/i |
| Matches in | 30 | /search/i,/plurality/i,/keyword/i,/action/i,/attribute/i,/document/i,/execut/i,/field/i,/data\s*structure/i,/match/i,/threshold/i,/hierarchical |
| US7613602.pdf | | /i,/relationships/i,/document\s*of\s*interest/i,/pattern/i,/mismatch/i,/user/i,/overlap/i,/association/i,/import/i,/frequency/i,/relevan/i,/handle/i,/reference/ |
| | | i,/identi/i,/extract/i,/index/i,/page/i,/\btag/i,/element/i |
| Matches in | 22 | /search/i,/plurality/i,/keyword/i,/attribute/i,/document/i,/execut/i,/field/i,/data\s*structure/i,/match/i,/threshold/i,/queries/i,/user |
| US7657515.pdf | | /i,/import/i,/phrase/i,/relevan/i,/reference/i,/identi/i,/index/i,/page/i,/command/i,/couple/i,/element/i |
| Matches in | 32 | /search/i,/action/i,/attribute/i,/document/i,/field/i,/regular\s*expression/i,/match/i,/threshold/i,/hierarchical/i,/pattern/i,/delimited |
| US7743061.pdf | | /i,/user/i,/overlap/i,/association/i,/import/i,/frequency/i,/phrase/i,/cluster/i,/relevan/i,/pointer/i,/handle/i,/reference/i,/identi/i,/extract/i,/render/i,/aggregat/i,/ |
| | | index/i,/page/i,/fingerprint/i,/element/i,/array/i,/vector/i |
| Matches in | 25 | /search/i,/plurality/i,/action/i,/document/i,/execut/i,/field/i,/match/i,/patter/i,/context/i,/user/i,/adaptive/i,/association/i,/import |
| US7751624.pdf | | /i,/collection/i,/phrase/i,/relevan/i,/reference/i,/identi/i,/extract/i,/index/i,/page/i,/command/i,/couple/i,/element/i,/array/i |
| Matches in | 33 | /search/i,/grouping/i,/plurality/i,/keyword/i,/action/i,/attribute/i,/document/i,/execut/i,/field/i,/match/i,/hierarchical/i,/queries/ |
| US7836077.pdf | | i,/relationships/i,/querying/i,/classification/i,/linked/i,/subset/i,/context/i,/user/i,/association/i,/import/i,/frequency/i,/dictionar/i,/phrase/i,/cluster/i,/ranking/i,/ |
| | | relevan/i,/reference/i,/identi/i,/trigger/i,/extract/i,/page/i,/\btag/i |
| US7836391.pdf | page 1 | Assignee: Google Inc. (Mountain View, CA) |
| Matches in | 24 | /search/i,/plurality/i,/action/i,/document/i,/execut/i,/field/i,/match/i,/threshold/i,/queries/i,/classification/i,/linked/i,/context/i,/ |
| US7836391.pdf | | user/i,/import/i,/classify/i,/ranking/i,/relevan/i,/reference/i,/identi/i,/render/i,/index/i,/page/i,/couple/i,/element/i |
| Matches in | 18 | /search/i,/plurality/i,/document/i,/execut/i,/field/i,/data\s*structure/i,/threshold/i,/frequency/i,/dictionar/i,/collection/i,/cluster |
| US7937389.pdf | | /i,/relevan/i,/reference/i,/identi/i,/index/i,/page/i,/element/i,/vector/i |
| Matches in | 19 | /search/i,/keyword/i,/document/i,/execut/i,/field/i,/match/i,/threshold/i,/queries/i,/pattern/i,/user/i,/modify/i,/relevan/i,/reference |
| US7966307.pdf | | /i,/identi/i,/extract/i,/index/i,/page/i,/element/i,/array/i |
| Matches in | 15 | /search/i,/plurality/i,/document/i,/field/i,/match/i,/threshold/i,/association/i,/frequency/i,/dictionar/i,/reference/i,/identi/i,/extract |
| US7979438.pdf | | /i,/index/i,/page/i,/array/i |
| Matches in | 40 | /search/i,/plurality/i,/keyword/i,/action/i,/attribute/i,/document/i,/execut/i,/field/i,/data\s*structure/i,/match/i,/threshold/i,/queries |
| US7984035.pdf | | /i,/relationships/i,/classification/i,/linked/i,/subset/i,/pattern/i,/context/i,/user/i,/association/i,/import/i,/frequency/i,/phrase |
| | | /i,/classify/i,/ranking/i,/relevan/i,/reference/i,/identi/i,/trigger/i,/extract/i,/render/i,/aggregat/i,/metadata/i,/index/i,/page/i,/command/i,/\btag/i,/couple/i,/element/i,/vector/i |
| Matches in | 26 | /search/i,/grouping/i,/plurality/i,/action/i,/document/i,/execut/i,/field/i,/match/i,/threshold/i,/queries/i,/relationships/i,/subset/i, |
| US7996367.pdf | | /context/i,/user/i,/overlap/i,/association/i,/modify/i,/relevan/i,/indirect/i,/handle/i,/reference/i,/identi/i,/extract/i,/metadata/i,/page/i,/command/i |
| Matches in | 25 | /search/i,/plurality/i,/keyword/i,/action/i,/document/i,/execut/i,/field/i,/hierarchical/i,/queries/i,/linked/i,/user/i,/adaptive/i,/association |
| US8032550.pdf | | /i,/collection/i,/phrase/i,/relevan/i,/reference/i,/identi/i,/extract/i,/index/i,/page/i,/couple/i,/element/i,/array/i,/vector/i |
| Matches in | 21 | /search/i,/plurality/i,/attribute/i,/document/i,/execut/i,/field/i,/data\s*structure/i,/match/i,/hierarchical/i,/queries/i,/relationships |
| US8086561.pdf | | /i,/subset/i,/user/i,/modify/i,/reference/i,/identi/i,/extract/i,/index/i,/page/i,/\btag/i,/element/i |
| Matches in | 17 | /search/i,/plurality/i,/action/i,/document/i,/execut/i,/data\s*structure/i,/querying/i,/linked/i,/context/i,/user/i,/cluster/i,/relevan |
| US8117194.pdf | | /i,/reference/i,/identi/i,/index/i,/page/i,/couple/i |
| Matches in | 22 | /search/i,/keyword/i,/action/i,/document/i,/field/i,/match/i,/threshold/i,/classification/i,/subset/i,/context/i,/user/i,/import/i,/collection |
| US8140494.pdf | | /i,/phrase/i,/classify/i,/relevan/i,/reference/i,/identi/i,/extract/i,/metadata/i,/index/i,/page/i |
| Matches in | 20 | /search/i,/plurality/i,/keyword/i,/action/i,/document/i,/execut/i,/field/i,/match/i,/user/i,/import/i,/frequency/i,/collection/i,/phrase/i,/relevan/i,/reference/i,/ |
| US8145654.pdf | | identi/i,/index/i,/page/i,/\btag/i,/element/i |
| US8301603.pdf | page 7 | Widespread use of a web search system, such as Google (registered trademark), has made |
| Matches in | 21 | /search/i,/plurality/i,/keyword/i,/action/i,/attribute/i,/document/i,/execut/i,/field/i,/queries/i,/user/i,/association/i,/import/i,/frequency |
| US8301603.pdf | | /i,/ranking/i,/pointer/i,/reference/i,/identi/i,/trigger/i,/extract/i,/index/i,/page/i |
| US8364668.pdf | page 1 | Assignee: Google Inc. (Mountain View, CA) |
| US8364668.pdf | page 2 | Google Search; catalogs. google. com; Aug. 12, 2004 (print date); pp. 1-7. cited by |
| | page 2 | Google News; news. google. com; Aug. 12, 2004 (print date) pp. 1-4, cited by applicant. |
| Matches in | 15 | /search/i,/plurality/i,/document/i,/execut/i,/field/i,/queries/i,/linked/i,/user/i,/phrase/i,/relevan/i,/reference/i,/identi/i,/index/i,/ |
| US8364668.pdf | | page/i,/element/i |
| Matches in | 26 | /search/i,/plurality/i,/keyword/i,/action/i,/attribute/i,/document/i,/execut/i,/field/i,/data\s*structure/i,/match/i,/queries/i,/linked |
| US8407232.pdf | | /i,/user/i,/overlap/i,/association/i,/import/i,/frequency/i,/dictionar/i,/relevan/i,/reference/i,/identi/i,/extract/i,/index/i,/page/i,/element/i,/vector/i |
| Matches in | 19 | /search/i,/plurality/i,/action/i,/document/i,/execut/i,/field/i,/match/i,/threshold/i,/relationships/i,/document\s*of\s*interest/i,/user/i,/import/i,/frequency/i,/ranking/i,/ |
| US8429154.pdf | | reference/i,/identi/i,/extract/i,/page/i,/\btag/i |
| US8473487.pdf | page 1 | Assignee: Google Inc. (Mountain View, CA) |
| Matches in | 22 | /search/i,/pluralny/i,/action/i,/document/i,/execut/i,/field/i,/match/i,/queries/i,/pattern/i,/context/i,/user/i,/collection/i,/phrase/ |
| US8473487.pdf | | i,/ranking/i,/relevan/i,/reference/i,/identi/i,/metadata/i,/index/i,/page/i,/couple/i,/element/i |
| US8527534.pdf | page 2 | Retrieved at << http:// www. google. co. uk/ url? |
| Matches in | 23 | /search/i,/plurality/i,/keyword/i,/action/i,/document/i,/execut/i,/field/i,/data\s*structure/i,/match/i,/queries/i,/subset/i,/user/i,/adaptive |
| US8612423.pdf | | /i,/modify/i,/reference/i,/identi/i,/metadata/i,/index/i,/page/i,/command/i,/\btag/i,/couple/i,/element/i |
| Matches in | 14 | /search/i,/plurality/i,/keyword/i,/document/i,/execut/i,/field/i,/user/i,/import/i,/phrase/i,/relevan/i,/reference/i,/identi/i,/extract |
| US8775455.pdf | | /i,/page/i |
| Matches in | 29 | /search/i,/keyword/i,/action/i,/document/i,/execut/i,/field/i,/match/i,/pattern/i,/context/i,/user/i,/association/i,/frequency/i,/dictionar |
| US8898165.pdf | | /i,/collection/i,/phrase/i,/ranking/i,/relevan/i,/reference/i,/identi/i,/render/i,/metadata/i,/page/i,/command/i,/\btag/i,/fingerprint |
| | | /i,/couple/i,/element/i,/array/i,/vector/i |
| Matches in | 29 | /search/i,/keyword/i,/action/i,/document/i,/execut/i,/field/i,/match/i,/pattern/i,/context/i,/user/i,/association/i,/frequency/i,/dictionar |
| US8903813.pdf | | /i,/collection/i,/phrase/i,/ranking/i,/relevan/i,/reference/i,/identi/i,/render/i,/metadata/i,/page/i,/command/i,/\btag/i,/fingerprint/i,/couple/i,/element/i,/array/i,/vector/i |
| Matches in | 15 | /search/i,/plurality/i,/action/i,/document/i,/execut/i,/field/i,/match/i,/delimited/i,/user/i,/overlap/i,/handle/i,/reference/i,/identi |
| US8938123.pdf | | /i,/page/i,/vector/i |
| Matches in | 14 | /search/i,/plurality/i,/document/i,/execut/i,/field/i,/threshold/i,/pattern/i,/user/i,/overlap/i,/dictionar/i,/handle/i,/reference/i,/identi |
| US9020267.pdf | | /i,/page/i |
| Matches in | 21 | /search/i,/plurality/i,/document/i,/execut/i,/field/i,/match/i,/queries/i,/subset/i,/context/i,/user/i,/import/i,/frequency/i,/collection |
| US9098570.pdf | | /i,/phrase/i,/relevan/i,/reference/i,/identi/i,/extract/i,/render/i,/index/i,/page/i |
| Matches in | 29 | /search/i,/plurality/i,/document/i,/execut/i,/field/i,/data\s*structure/i,/threshold/i,/hierarchical/i,/relationships/i,/classification/ |
| US9189482.pdf | | i,/context/i,/user/i,/association/i,/import/i,/frequency/i,/dictionar/i,/collection/i,/phrase/i,/classify/i,/cluster/i,/reference/i,/identi |
| | | /i,/extract/i,/index/i,/page/i,/couple/i,/element/i,/array/i,/vector/i |
| US9189548.pdf | page 1 | Assignee: Google Inc. (Mountain View, CA) |
| Matches in | 23 | /search/i,/action/i,/document/i,/execut/i,/field/i,/match/i,/threshold/i,/queries/i,/classification/i,/linked/i,/context/i,/user/i,/import/i,/classify/i,/ranking/i,/relevan/i,/reference/i,/ |
| US9189548.pdf | | identi/i,/render/i,/index/i,/page/i,/couple/i,/element/i |
| Matches in | 14 | /search/i,/plurality/i,/keyword/i,/document/i,/execut/i,/field/i,/user/i,/import/i,/phrase/i,/relevan/i,/reference/i,/identi/i,/extract |
| US9298710.pdf | | /i,/page/i |
| Matches in | 27 | /search/i,/keyword/i,/action/i,/document/i,/execut/i,/field/i,/match/i,/subset/i,/pattern/i,/context/i,/user/i,/overlap/i,/import/i,/frequency |
| US9342533.pdf | | /i,/phrase/i,/relevan/i,/reference/i,/identi/i,/extract/i,/render/i,/index/i,/page/i,/\btag/i,/fingerprint/i,/couple/i,/element |
| | | /i,/array/i |
| Matches in | 21 | /search/i,/plurality/i,/action/i,/document/i,/execut/i,/field/i,/data\s*structure/i,/match/i,/threshold/i,/queries/i,/pattern/i,/context/i,/user/i,/overlap/i,/modify/i,/ |
| US9384304.pdf | | indirect/i,/reference/i,/identi/i,/extract/i,/page/i,/vector/i |
| US9483534.pdf | page 1 | Google Inc. Mountain View CA US |
| | page 1 | Assignee: Google Inc, (Mountain View, CA) |
| US9483534.pdf | page 3 | Google Search: http:// catalogs. google. com; Aug. 12, 2004 (print date); pp. 1-7. cited by |
| | page 3 | Google News: http:// news. google. com; Aug. 12, 2004 (print date) pp. 1-4. cited by |
| Matches in | 14 | /search/i,/document/i,/execut/i,/field/i,/queries/i,/linked/i,/user/i,/phrase/i,/relevan/i,/reference/i,/identi/i,/index/i,/page/i,/element/i |
| US9483534.pdf | | |
| US9519707.pdf | page 20 | indexing of web references is done by, for example, the Google, TM. Internet search engine. |
| Matches in | 35 | /search/i,/plurality/i,/action/i,/attribute/i,/document/i,/execut/i,/field/i,/data\s*structure/i,/match/i,/hierarchical/i,/queries/i,/relationships |
| US9519707.pdf | | /i,/linked/i,/subset/i,/pattern/i,/context/i,/delimited/i,/user/i,/association/i,/collection/i,/cluster/i,/ranking/i,/relevan/i, |
| | | /indirect/i,/pointer/i,/reference/i,/identi/i,/render/i,/metadata/i,/index/i,/page/i,/command/i,/\btag/i,/couple/i,/element/i |
| US9529903.pdf | page 17 | indexing of web references is done by, for example, the Google. TM. Internet search engine. |
| Matches in | 34 | /search/i,/plurality/i,/action/i,/attribute/i,/document/i,/execut/i,/field/i,/data\s*structure/i,/match/i,/hierarchical/i,/queries/i,/relationships |
| US9529903.pdf | | /i,/linked/i,/subset/i,/pattern/i,/context/i,/delimited/i,/user/i,/association/i,/collection/i,/cluster/i,/relevan/i,/indirect/i,/pointer/i,/reference/i,/identi/ |
| | | i,/render/i,/metadata/i,/index/i,/page/i,/command/i,/\btag/i,/couple/i,/element/i |
| Matches in | 27 | /search/i,/keyword/i,/action/i,/document/i,/execut/i,/field/i,/match/i,/subset/i,/pattern/i,/context/i,/user/i,/overlap/i,/import/i,/frequency |
| US9563690.pdf | | /i,/phrase/i,/relevan/i,/reference/i,/identi/i,/extract/i,/render/i,/index/i,/page/i,/\btag/i,/fingerprint/i,/couple/i,/element/i,/array/i |
| Matches in | 29 | /search/i,/plurality/i,/keyword/i,/action/i,/attribute/i,/document/i,/execut/i,/field/i,/data\s*structure/i,/match/i,/threshold/i,/queries |
| US9600529.pdf | | /i,/classification/i,/subset/i,/user/i,/frequency/i,/dictionar/i,/phrase/i,/ranking/i,/relevan/i,/reference/i,/identi/i,/extract/i,/render |
| | | /i,/page/i,/couple/i,/element/i,/array/i,/vector/i |
| Matches in | 14 | /search/i,/document/i,/execut/i,/field/i,/data\s*structure/i,/match/i,/threshold/i,/user/i,/adaptive/i,/handle/i,/reference/i,/identi/ |
| US9697422.pdf | | i,/index/i,/page/i |
| US8527534.pdf | page 3 | <<http:// googleresearch. blogspot. com/ 2006/ 08/ all-our-n-gram-are-bel-ong-to-you. |
| Matches in | 30 | /search/i,/action/i,/document/i,/execut/i,/field/i,/data\s*structure/i,/match/i,/queries/i,/linked/i,/pattern/i,/mismatch/i,/context/ |
| US8527534.pdf | | i,/user/i,/adaptive/i,/association/i,/frequency/i,/collection/i,/classify/i,/cluster/i,/ranking/i,/relevan/i,/reference/i,/identi/i,/metadata/i,/index/i,/page/i,/\btag/i,/couple/i,/element/i,/vector/i |
| Matches in | 26 | /search/i,/grouping/i,/plurality/i,/action/i,/document/i,/execut/i,/field/i,/match/i,/threshold/i,/queries/i,/relationships/i,/subset/i, |
| US8539004.pdf | | /context/i,/user/i,/overlap/i,/association/i,/modify/i,/relevan/i,/indirect/i,/handle/i,/reference/i,/identi/i,/extract/i,/metadata/i,/page/i,/command/i |
| Matches in | 24 | /search/i,/action/i,/attribute/i,/document/i,/execut/i,/field/i,/match/i,/queries/i,/classification/i,/subset/i,/pattern/i,/user/i,/adaptive |
| US8577865.pdf | | /i,/association/i,/cluster/i,/reference/i,/identi/i,/metadata/i,/page/i,/subroutine/i,/\btag/i,/couple/i,/element/i,/array/i |
| Matches in | 20 | /search/i,/plurality/i,/keyword/i,/action/i,/document/i,/execut/i,/field/i,/match/i,/user/i,/import/i,/frequency/i,/collection/i,/phrase/i,/relevan/i,/reference/i,/ |
| US8600972.pdf | | identi/i,/index/i,/page/i,/\btag/i,/element/i |
| US8612423.pdf | page 2 | Berardi, Nick., OmniSearch (Google Caching Engine)”, Retrieved at>> |

TABLE 3
Final output showing similarity ranking.²

| Source doc | Target doc | Score | Keywords |
|---|---|---|---|
| US2009171938 | U.S. Pat. No. 7,984,035 | 70.14915 | /search/i,/plurality/i,/keyword/i,/action/i,/attribute/i,/document/i,/execut/i,/data\s*structure/i,/match/i,/threshold/ |
| | | | i,/queries/i,/relationships/i,/classification/i,/linked/i,/subset/i,/pattern/i,/context/i,/user/i,/association/i,/import/i,/ |
| | | | frequency/i,/phrase/i,/classify/i,/ranking/i,/relevan/i,/reference/i,/identi/i,/trigger/i,/render/i,/aggregat/i,/metadata/i,/index/i,/page/i,/command/i,/ |
| | | | \btag/i,/couple/i,/element/i,/vector/i |
| US2010198816 | U.S. Pat. No. 7,984,035 | 61.19403 | /search/i,/plurality/i,/keyword/i,/action/i,/attribute/i,/document/i,/execut/i,/field/i,/data\s*structure/i,/data\s*object/ |
| | | | i,/match/i,/threshold/i,/hierarchical/i,/queries/i,/relationships/i,/classification/i,/linked/i,/context/i,/user/i,/association/i,/ |
| | | | import/i,/dictionar/i,/phrase/i,/classify/i,/relevan/i,/pointer/i,/reference/i,/identi/i,/render/i,/metadata/i,/index/i,/page/i,/\btag,/i,/couple/i,/element/i,/vector/i |
| US2003014428 | U.S. Pat. No. 7,984,035 | 58.20896 | /search/i,/keyword/i,/action/i,/attribute/i,/document/i,/execut/i,/field/i,/data\s*structure/i,/match/i,/hierarchical/i,/ |
| | | | queries/i,/relationships/i,/classification/i,/linked/i,/subset/i,/pattern/i,/context/i,/user/i,/import/i,/phrase/i,/cluster/i,/relevan/i,/pointer/i,/handle/i,/ |
| | | | reference/i,/identi/i,/trigger/i,/extract/i,/index/i,/page/i,/command/i,/\btag/i,/element/i,/vector/i |
| US2008263036 | U.S. Pat. No. 7,984,035 | 56.71642 | /search/i,/grouping/i,/plurality/i,/keyword/i,/action/i,/attribute/i,/document/i,/execut/i,/field/i,/data\s*structure/i,/ |
| | | | regular\s*expression/i,/match/i,/threshold/i,/classification/i,/subset/i,/pattern/i,/context/i,/user/i,/association/i,/ |
| | | | modify/i,/import/i,/classify/i,/cluster/i,/handle/i,/reference/i,/identi/i,/extract/i,/render/i,/index/i,/page/i,/command/i,/\btag/i,/couple/i,/array/i,/vector/i |
| US2016350315 | U.S. Pat. No. 7,984,035 | 56.71642 | /search/i,/plurality/i,/keyword/i,/action/i,/attribute/i,/document/i,/execut/i,/field/i,/data\s*structure/i,/match/i,/threshold/ |
| | | | i,/queries/i,/relationships/i,/linked/i,/subset/i,/context/i,/user/i,/phrase/i,/ranking/i,/relevan/i,/pointer/i,/reference/i,/identi/i,/extract/i,/render/i,/ |
| | | | aggregat/i,/metadata/i,/index/i,/page/i,/\btag/i |
| US2002002452 | U.S. Pat. No. 7,984,035 | 52.23881 | /search/i,/plurality/i,/action/i,/attribute/i,/document/i,/execut/i,/field/i,/match/i,/queries/i,/relationships/i,/querying/ |
| | | | i,/pattern/i,/context/i,/user/i,/association/i,/frequency/i,/collection/i,/phrase/i,/ranking/i,/relevan/i,/handle/i,/reference/i,/identi/i,/extract/i,/render/ |
| | | | i,/index/i,/page/i,/\btag/i,/element/i |
| US2014236986 | U.S. Pat. No. 7,984,035 | 52.23881 | /search/i,/plurality/i,/action/i,/attribute/i,/document/i,/execut/i,/field/i,/data\s*structure/i,/queries/i,/relationships/ |
| | | | i,/subset/i,/context/i,/user/i,/association/i,/import/i,/frequency/i,/dictionar/i,/phrase/i,/relevan/i,/indirect/i,/reference/i,/identi/i,/metadata/i,/index/i,/page/ |
| | | | i,/command/i,/couple/i,/element/i,/array/i |
| US2015213012 | U.S. Pat. No. 7,984,035 | 52.23881 | /search/i,/plurality/i,/keyword/i,/action/i,/document/i,/execut/i,/field/i,/data\s*structure/i,/threshold/i,/subset/i,/ |
| | | | pattern/i,/user/i,/import/i,/frequency/i,/phrase/i,/cluster/i,/ranking/i,/relevan/i,/indirect/i,/reference/i,/identi/i,/extract/i,/metadata/i,/index/i,/page/ |
| | | | i,/\btag/i,/couple/i,/element/i |
| U.S. Pat. No. 7,984,035 | US2009171938 | 71.14418 | /search/i,/plurality/i,/keyword/i,/action/i,/attribute/i,/document/i,/execut/i,/field/i,/data\s*structure/i,/match/i,/threshold/ |
| | | | i,/queries/i,/relationships/i,/classification/i,/linked/i,/subset/i,/pattern/i,/context/i,/user/i,/association/i,/import/ |
| | | | i,/frequency/i,/phrase/i,/classify/i,/ranking/i,/relevan/i,/reference/i,/identi/i,/trigger/i,/extract/i,/render/i,/aggregat/i,/metadata/i,/index/i,/page/i,/ |
| | | | command/i,/\btag/i,/couple/i,/element/i,/vector/i |
| U.S. Pat. No. 6,718,333 | US2010198816 | 49.75124 | /search/i,/grouping/i,/keyword/i,/attribute/i,/document/i,/execut/i,/field/i,/match/i,/threshold/i,/hierarchical/i,/relationships/ |
| | | | i,/classification/i,/linked/i,/context/i,/user/i,/association/i,/collection/i,/phrase/i,/classify/i,/relevan/i,/reference/i,/identi/i,/extract/i,/index/i,/page/i,/\btag/i |
| U.S. Pat. No. 5,832,474 | US2008263036 | 51.74129 | /search//i,/plurality/i,/keyword/i,/action/i,/document/i,/field/i,/data\s*structure/i,/match/i,/queries/i,/classification/ |
| | | | i,/subset/i,/document\s*of\s*interest/i,/pattern/i,/user/i,/association/i,/import/i,/cluster/i,/ranking/i,/relevan/i,/ |
| | | | pointer/i,/handle/i,/reference/i,/identi/i,/extract/i,/render/i,/index/i,/page/i,/couple/i,/vector/i |
| U.S. Pat. No. 9,519,707 | US2010257161 | 68.1592 | /search/i,/plurality/i,/action/i,/attribute/i,/document/i,/execut/i,/field/i,/data\s*structure/i,/match/i,/hierarchical/i,/ |
| | | | queries/i,/relationships/i,/linked/i,/subset/i,/pattern/i,/context/i,/delimited/i,/user/i,/association/i,/collection/i,/cluster/ |
| | | | i,/ranking/i,/relevan/i,/indirect/i,/pointer/i,/reference/i,/identi/i,/render/i,/metadata/i,/index/i,/page/i,/command/i,/\btag/i,/couple/i,/element/i |
| US2010257161 | U.S. Pat. No. 9,519,707 | 68.1592 | /search/i,/plurality/i,/action/i,/attribute/i,/document/i,/execut/i,/field/i,/data\s*structure/i,/match/i,/hierarchical/i,/ |
| | | | queries/i,/relationships/i,/linked/i,/subset/i,/pattern/i,/context/i,/delimited/i,/user/i,/association/i,/collection/i,/cluster/i,/ranking/i,/relevan/i,/ |
| | | | indirect/i,/pointer/i,/reference/i,/identi/i,/render/i,/metadata/i,/index/i,/page/i,/command/i,/\btag/i,/couple/i,/element/i |
| U.S. Pat. No. 9,529,903 | US2007255686 | 67.16418 | /search/i,/plurality/i,/action/i,/attribute/i,/document/i,/execut/i,/field/i,/data\s*structure/i,/match/i,/hierarchical/,/ |
| | | | queries/i,/relationships/i,/linked/i,/subset/i,/pattern/i,/context/i,/delimited/i,/user/i,/association/i,/collection/i,/cluster/ |
| | | | i,/relevan/i,/indirect/i,/pointer/i,/reference/i,/identi/i,/render/i,/metadata/i,/index/i,/page/i,/command/i,/\btag/i,/couple/i,/element/i |
| US2005102251 | U.S. Pat. No. 7,185,001 | 52.23881 | /search/i,/grouping/i,/keyword/i,/action/i,/document/i,/match/i,/threshold/i,/queries/i,/classification/i,/subset/i,/pattern/ |
| | | | i,/context/i,/user/i,/adaptive/i,/import/i,/frequency/i,/collection/i,/phrase/i,/classify/i,/cluster/i,/ranking/i,/relevan/i,/pointer/i,/handle/i,/reference/i,/identi/i,/ |
| | | | extract/i,/metadata/i,/index/i,/element/i,/vector/i |
| US2007255686 | U.S. Pat. No. 9,529,903 | 67.16418 | /search/i,/plurality/i,/action/i,/attribute/i,/document/i,/execut/i,/field/i,/data\s*structure/i,/match/i,/hierarchical/i,/ |
| | | | queries/i,/relationships/i,/linked/i,/subset/i,/pattern/i,/context/i,/delimited/i,/user/i,/association/i,/collection/i,/cluster/ |
| | | | i,/relevan/i,/indirect/i,/pointer/i,/reference/i,/identi/i,/render/i,/metadata/i,/index/i,/page/i,/command/i,/\btag/i,/couple/i,/element/i |
| US2008140657 | U.S. Pat. No. 7,836,077 | 61.69154 | /search/i,/grouping/i,/plurality/i,/keyword/i,/action/i,/attribute/i,/document/i,/execut/i,/field/i,/match/i,/hierarchical/ |
| | | | i,/queries/i,/relationships/i,/linked/i,/subset/i,/context/i,/user/i,/import/i,/frequency/i,/dictionar/i,/phrase/i,/cluster/i,/ranking/i,/relevan/i,/reference/ |
| | | | i,/identi/i,/trigger/i,/extract/i,/page/i,/\btag/i |
| U.S. Pat. No. 7,743,061 | US2004098389 | 65.17413 | /search/i,/action/i,/attribute/i,/document/i,/field/i,/regular\s*expression/i,/match/i,/thresholdl/ |
| | | | i,/hierarchical/i,/pattern/i,/delimited/i,/user/i,/overlap/i,/association/i,/import/i,/frequency/i,/phrase/i,/cluster/i,/relevan/i,/pointer/i,/handle/ |
| | | | i,/reference/i,/identi/i,/extract/i,/render/i,/aggregat/i,/index/i,/page/i,/fingerprint/i,/element/i,/array/i,/vector/i |
| US2004103090 | U.S. Pat. No. 5,983,221 | 53.23383 | /search/i,/plurality/i,/action/i,/document/i,/execut/i,/field/i,/data\s*structure/i,/regular\s*expression/i,/match/i,/hierarchical/ |
| | | | i,/queries/i,/linked/i,/context/i,/user/i,/modify/i,/import/i,/frequency/i,/collection/i,/cluster/i,/ranking/ |
| | | | i,/relevan/i,/handle/i,/reference/i,/identi/i,/render/i,/index/i,/page/i |
| US2004098389 | U.S. Pat. No. 7,743,061 | 65.17413 | /search/i,/action/i,/attribute/i,/document/i,/field/i,/regular\s*expression/i,/match/i,/threshold/i,/hierarchical/i,/pattern/ |
| | | | i,/delimited/i,/user/i,/overlap/i,/association/i,/import/i,/frequency/i,/phrase/i,/cluster/i,/relevan/i,/pointer/i,/handle/i,/reference/i,/identi/i,/extract/i,/render/ |
| | | | i,/aggregat/i,/index/i,/page/i,/fingerprint/i,/element/i,/array/i,/vector/i |
| U.S. Pat. No. 7,613,602 | US2007027671 | 63.18408 | /search/i,/plurality/i,/keyword/i,/action/i,/attribute/i,/document/i,/execut/i,/field/i,/data\s*structure/i,/match/i,/threshold/ |
| | | | i,/hierarchical/i,/relationships/i,/document\s*of\s*interest/i,/pattern/i,/mismatch/i,/user/i,/overlap/i,/association/i,/import/i,/frequency/i,/relevan/i,/ |
| | | | handle/i,/reference/i,/identi/i,/extract/i,/index/i,/page/i,/\btag/i,/element/i |
| U.S. Pat. No. 7,836,077 | US2008140657 | 63.18408 | /search/i,/grouping/i,/plurality/i,/keyword/i,/action/i,/attribute/i,/document/i,/execut/i,/field/i,/match/i,/hierarchical/ |
| | | | i,/queries/i,/relationships/i,/querying/i,/classification/i,/linked/i,/subset/i,/context/i,/user/i,/association/i,/import/ |
| | | | i,/frequency/i,/dictionar/i,/phrase/i,/cluster/i,/ranking/i,/relevan/i,/reference/i,/identi/i,/trigger/i,/extract/i,/page/i,/\btag/i |
| U.S. Pat. No. 5,983,221 | US2008140657 | 55.72139 | /search/i,/plurality/i,/keyword/i,/action/i,/document/i,/execut/i,/field/i,/match/i,/hierarchical/i,/queries/i,/relationships/ |
| | | | i,/linked/i,/subset/i,/context/i,/user/i,/modify/i,/import/i,/frequency/i,/phrase/i,/cluster/i,/ranking/i,/relevan/i,/handle/i,/reference/i,/identi/i,/extract/i,/ |
| | | | query\s*word/i,/render/i,/index/i,/page/i,/command/i,/element/i |
| US2009112841 | US2016350315 | 52.73632 | /search/i,/grouping/i,/keyword/i,/action/i,/attribute/i,/document/i,/execut/i,/field/i,/regular\s*expression/i,/match/ |
| | | | i,/queries/i,/relationships/i,/context/i,/user/i,/overlap/i,/association/i,/import/i,/collection/i,/phrase/i,/cluster/i,/relevan/ |
| | | | i,/indirect/i,/pointer/i,/handle/i,/reference/i,/identi/i,/extract/i,/aggregat/i,/metadata/i,/index/i,/page/i,/\btag/i,/couple/i |
| US2013275420 | US2016350315 | 49.75124 | /search/i,/plurality/i,/keyword/i,/action/i,/document/i,/execut/i,/field/i,/match/i,/threshold/i,/queries/i,/subset/i,/user/ |
| | | | i,/frequency/i,/ranking/i,/relevan/i,/pointer/i,/handle/i,/reference/i,/identi/i,/metadata/i,/index//i,/page/i,/\btag/i,/couple/i |
| US2007027671 | U.S. Pat. No. 7,613,602 | 63.18408 | /search/i,/plurality/i,/keyword/i,/action/i,/attribute/i,/document/i,/execut/i,/field/i,/data\s*structure/i,/match/i,/threshold/ |
| | | | i,/hierarchical/i,/relationships/i,/document\s*of\s*interest/i,/pattern/i,/mismatch/i,/user/i,/overlap/i,/association/i,/import/i,/frequency/i,/relevan/ |
| | | | i,/handle/i,/reference/i,/identi/i,/extract/i,/index/i,/page/i,/\btag/i,/element/i |
| US2011231394 | U.S. Pat. No. 8,527,534 | 58.70647 | /search/i,/document/i,/execut/i,/field/i,/data\s*structure/i,/match/i,/queries/i,/linked/i,/pattern/i,/mismatch/i,/context/ |
| | | | i,/user/i,/adaptive/i,/frequencyl/i,/collection/i,/classify/i,/ranking/i,/relevan/i,/reference/i,/identi/i,/metadata/i,/index/i,/page/i,/\btag/i,/ |
| | | | couple/i,/element/i,/vector/i |
| U.S. Pat. No. 7,657,515 | US2014236986 | 47.26368 | /search/i,/plurality/i,/keyword/i,/attribute/i,/document/i,/execut/i,/field/i,/data\s*structure/i,/match/i,/threshold/i, |
| | | | queries/i,/user/i,/import/i,/phrase/i,/relevan/i,/reference/i,/identi/i,/index/i,/page/i,/command/i,/couple/i,/element/i |
| U.S. Pat. No. 8,903,813 | U.S. Pat. No. 8,898,165 | 62.18905 | /search/i,/keyword/i,/action/i,/document/i,/execut/i,/field/i,/match/i,/pattern/i,/context/i,/user/i,/association/i,/frequency/ |
| | | | i,/dictionar/i,/collection/i,/phrase/i,/ranking/i,/relevan/i,/reference/i,/identi/i,/render/i,/metadata/i,/page/i,command/i,/\btag/i,/fingerprint/i,/ |
| | | | couple/i,/element/i,/array/i,/vector/i |
| U.S. Pat. No. 8,898,165 | U.S. Pat. No. 8,903,813 | 62.18905 | /search/i,/keyword/i,/action/i,/document/i,/execut/i,/field/i,/match/i,/pattern/i,/context/i,/user/i,/association/i,/frequency/ |
| | | | i,/dictionar/i,/collection/i,/phrase/i,/ranking/i,/relevan/i,/reference/i,/identi/i,/render/i,/metadata/i,/page/i,/command/i,/\btag/i,/fingerprint/ |
| | | | i,/couple/i,/element/i,/array/i,/vector/i |
| US2014101171 | U.S. Pat. No. 9,189,482 | 60.69652 | /search/i,/plurality/i,/document/i,/execut/i,/field/i,/data\s*structure/i,/threshold/i,/hierarchical/i,/relationships/i,/ |
| | | | classification/i,/context/i,/user/i,/import/i,/frequency/i,/dictionar/i,/collection/i,/phrase/i,/classify/i,/cluster/i,/reference/i,/identi/i,/extract/i,/index/i,/page/i,/ |
| | | | couple/i,/element/i,/array/i,/vector/i |
| US2014280082 | U.S. Pat. No. 9,600,529 | 60.69652 | /search/i,/plurality/i,/keyword/i,/action/i,/attribute/i,/document/i,/execut/i,/field/i,/data\s*structure/i,/match/i,/threshold/ |
| | | | i,/queries/i,/classification/i,/subset/i,/user/i,/frequency/i,/dictionar/i,/phrase/i,/ranking/i,/relevan/i,/reference/i,/identi/i,/extract/i,/render/i,/couple/i,/ |
| | | | element/i,/array/i,/vector/i |
| U.S. Pat. No. 9,189,482 | US2014101171 | 61.19403 | /search/i,/plurality/i,/document/i,/execut/i,/field/i,/data\s*structure/i,/threshold/i,/hierarchical/i,/relationships/i,/ |
| | | | classification/i,/context/i,/user/i,/association/i,/import/i,/frequency/i,/dictionar/i,/collection/i,/phrase/i,/classify/i,/cluster/i,/reference/i,/identi/i,/extract/i,/ |
| | | | index/i,/page/i,/couple/i,/element/i,/array/i,/vector/i |
| U.S. Pat. No. 9,600,529 | US2014280082 | 61.19403 | /search/i,/plurality/i,/keyword/i,/action/i,/attribute/i,/document/i,/execut/i,/field/i,/data\s*structure/i,/match/threshold/ |
| | | | i,/queries/i,/classification/i,/subset/i,/user/i,/frequency/i,/dictionar/i,/phrase/i,/ranking/i,/relevan/i,/reference/i,/identi/i,/extract/i,/render/i,/page/i,/couple/i,/ |
| | | | element/i,/array/i,/vector/i |
| U.S. Pat. No. 7,584,179 | US2004103090 | 45.27363 | /search/i,/document/i,/execut/i,/field/i,/data\s*structure/i,/queries/i,/context/i,/user/i,/overlap/i,/association/i,/modify |
| | | | i,/import/i,/phrase/i,/ranking/i,/relevan/i,/pointer/i,/reference/i,/identi/i,/render/i,/index/i,/page/i |
| U.S. Pat. No. 8,527,534 | US2011231394 | 60.199 | /search/i,/action/i,/document/i,/execut/i,/field/i,/data\s*structure/i,/match/i,/queries/i,/linked/i,/pattern/i,/mismatch/ |
| | | | i,/context/i,/user/i,/adaptive/i,/association/i,/frequency/i,/collection/i,/classify/i,/cluster/i,/ranking/i,/relevan/i,/reference/i,/identi/i,/metadata/i,/index/i,/ |
| | | | page/i,/\btag/i,/couple/i,/element/i,/vector/i |
| US2003187834 | US2013124515 | 51.24378 | /search/i,/plurality/i,/keyword/i,/action/i,/document/i,/execut/i,/field/i,/threshold/i,/relationships/i,/classification/ |
| | | | i,/user/i,/import/i,/frequency/i,/dictionar/i,/phrase/i,/relevan/i,/reference/i,/identi/i,/extract/i,/page/i,/\btag/i,/element/i,/vector/i |
| US2016232228 | US2015010235 | 60.199 | /search/i,/keyword/i,/action/i,/document/i,/execut/i,/field/i,/match/i,/subset/i,/pattern/i,/context/i,/user/i,/overlap/ |
| | | | i,/import/i,/frequency/i,/phrase/i,/relevan/i,/reference/i,/identi/i,/extract/i,/render/i,/index/i,/page/i,/\btag/i,/fingerprint/i,/couple/i,/element/i,/array/i |
| US2017109375 | US2015010235 | 60.199 | /search/i,/keyword/i,/action/i,/document/i,/execut/i,/field/i,/match/i,/subset/i,/pattern/i,/context/i,/user/i,/overlap/ |
| | | | i,/import/i,/frequency/i,/phrase/i,/relevan/i,/reference/i,/identi/i,/extract/i,/render/i,/index/i,/page/i,/\btag/i,/fingerprint/i,/couple/i,/element/i,/array/i |
| U.S. Pat. No. 9,342,533 | US2015010235 | 60.199 | /search/i,/keyword/i,/action/i,/document/i,/execut/i,/field/i,/match/i,/subset/i,/pattern/i,/context/i,/user/i,/overlap/ |
| | | | i,/import/i,/frequency/i,/phrase/i,/relevan/i,/reference/i,/identi/i,/extract/i,/render/i,/index/i,/page/i,/\btag/i,/fingerprint/i,/couple/i,/element/i,/array/i |
| U.S. Pat. No. 9,563,690 | US2015010235 | 60.199 | /search/i,/keyword/i,/action/i,/document/i,/execut/i,/field/i,/match/i,/subset/i,/pattern/i,/context/i,/user/i,/overlap/i,/import/i,/frequency/i,/phrase/i,/ |
| | | | relevan/i,/reference/i,/identi/i,/extract/i,/render/i,/index/i,/page/i,/\btag/i,/fingerprint,/i,/couple/i,/element/i,/array/i |
| US2015010235 | US2016232228 | 60.199 | /search/i,/keyword/i,/action/i,/document/i,/execut/i,/field/i,/match/i,/subset/i,/pattern/i,/context/i,/user/i,/overlap/ |
| | | | i,/import/i,/frequency/i,/phrase/i,/relevan,/reference/i,/identi/i,/extract/i,/render/i,/index/i,/page/i,/\btag/i,/fingerprint/i,/couple/i,/element/i,/array/i |
| U.S. Pat. No. 7,225,181 | US2001020238 | 59.20398 | /search/i,/plurality/i,/keyword/i,/attribute/i,/document/i,/execut/i,/field/i,/match/i,/hierarchical/i,/linked/i,/delimited/ |
| | | | i,/user/i,/import/i,/frequency/i,/dictionar/i,/cluster/i,/relevan/i,/pointer/i,/reference/i,/identi/i,/extract/i,/index/i,/page/i,/command/i,/\btag/i,/element/i |
| US2013268554 | US2001020238 | 45.77114 | /search/i,/plurality/i,/keyword/i,/document/i,/execut/i,/field/i,/hierarchical/i,/context/i,/user/i,/import/i,/dictionar/i,/relevan/i,/ |
| | | | reference/i,/identi/i,/extract/i,/page/i,/\btag/i,/element/i |
| US2011264995 | US2007198533 | 59.20398 | /search/i,/grouping/i,/plurality/i,/action/i,/document/i,/execut/i,/field/i,/match/i,/thresholdl/i,/queries/i,/relationships/ |
| | | | i,/subset/i,/context/i,/user/i,/overlap/i,/association/i,/modify/i,/relevan/i,/indirect/i,/handle/i,/reference/i,/identi/i,/extract/i,/metadata/i,/page/i,/command/i |
| U.S. Pat. No. 7,996,367 | US2007198533 | 59.20398 | /search/i,/grouping/i,/plurality/i,/action/i,/document/i,/execut/i,/field/i,/match/i,/threshold/i,/queries/i,/relationships/ |
| | | | i,/subset/i,/context/i,/user/i,/overlap/i,/association/i,/modify/i,/relevan/i,/indirect/i,/handle/i,/reference/i,/identi/i,/extract/i,/metadata/i,/page/i,/command/i |
| U.S. Pat. No. 8,539,004 | US2007198533 | 59.20398 | /search/i,/grouping/i,/plurality/i,/action/i,/document/i,/execut/i,/field/i,/match/i,/threshold/i,/queries/i,/relationships/ |
| | | | i,/subset/i,/context/i,/user/i,/overlap/i,/association/i,/modify/i,/relevan/i,/indirect/i,/handle/i,/reference/i,/identi/i,/extract/i,/metadata/i,/page/i,/command/i |
| US2007198533 | US2011264995 | 59.20398 | /search/i,/grouping/i,/plurality/i,/action/i,/document/i,/execut/i,/field/i,/match/i,/threshold/i,/queries/i,/relationships |
| | | | i,/subset/i,/context/i,/user/i,/overlap/i,/association/i,/modify/i,/relevan/i,/indirect/i,/handle/i,/reference/i,/identi |
| | | | i,/extract/i,/metadata/i,/page/i,/command/i |
| US2001020238 | U.S. Pat. No. 7,225,181 | 59.20398 | /search/i,/plurality/i,/keyword/i,/attribute/i,/document/i,/execut/i,/field/i,/match/i,/hierarchical/i,/linked/i,/delimited/ |
| | | | i,/user/i,/import/i,/frequency/i,/dictionar/i,/cluster/i,/relevan/i,/pointer/i,/reference/i,/identi/i,/extract/i,/index/i,/page/i,/command/i,/\btag/i,/element/i |
| US2011082878 | U.S. Pat. No. 8,407,232 | 56.21891 | /search/i,/plurality/i,/keyword/i,/attribute/i,/document/i,/execut/i,/field/i,/data\s*structure/i,/match/i,/queries/i,/linked/i,/user/i,/overlap/i,/ |
| | | | association/i,/import/i,/frequency/i,/dictionar/i,/relevan/i,/reference/i,/extract/i,/index/i,/page/i,/element/i,/vector/i |
| US2016246851 | U.S. Pat. No. 8,407,232 | 51.74129 | /search/i,/plurality/i,/action/i,/document/i,/execut/i,/field/i,/match/i,/threshold/i,/queries/i,/relationships/i,/subset/i,/user/i,/overlap/i,/association/ |
| | | | i,/import/i,/frequency/i,/dictionar/i,/relevan/i,/reference/i,/extract/i,/index/i,/page/i,/element/i,/vector/i |
| US2014032567 | U.S. Pat. No. 8,407,232 | 47.26368 | /search/i,/plurality/i,/attribute/i,/document/i,/execut/i,/field/i,/data\s*structure/i,/context/i,/user/i,/overlap/i,/import/i,/frequency/i,/collection/i,/ |
| | | | cluster/i,/ranking/i,/relevan/i,/reference/i,/identi/i,/extract/i,/metadata/i,/index/i,/page/i,/vector/i |
| U.S. Pat. No. 8,301,603 | U.S. Pat. No. 8,407,232 | 47.26368 | /search/i,/plurality/i,/keyword/i,/action/i,/attribute/i,/document/i,/execut/i,/fieldl/i,/queries/i,/user/i,/association/i,/import/i,/frequency/i,/ranking/i,/ |
| | | | pointer/i,/reference/i,/identi/i,/trigger/i,/extract/i,/index/i,/page/i |
| US2007226193 | U.S. Pat. No. 8,407,232 | 45.77114 | /search/i,/plurality/i,/document/i,/execut/i,/field/i,/data\s*structure/i,/match/i,/queries/i,/querying/i,/classification/ |
| | | | i,/linked/i,/user/i,/association/i,/reference/i,/identi/i,/extract/i,/index/i,/page/i,/command/i,/subroutine/i,/element/i,/array/i |
| U.S. Pat. No. 6,094,647 | U.S. Pat. No. 5,748,953 | 52.23881 | /search/i,/plurality/i,/action/i,/document/i,/execut/i,/field/i,/match/i,/hierarchical/i,/relationships/i,/classification/ |
| | | | i,/pattern/i,/mismatch/i,/context/i,/user/i,/overlap/i,/import/i,/frequency/i,/dictionar/i,/collection/i,/phrase/i,/pointer/i,/reference/i,/identi/i,/extract/i,/ |
| | | | index/i,/page/i,/command/i |
| US2004267734 | U.S. Pat. No. 5,748,953 | 50.74627 | /search/i,/plurality/i,/keyword/i,/action/i,/document/i,/execut/i,/field/i,/match/i,/threshold/i,/pattern/i,/user/i,/import/ |
| | | | i,/frequency/i,/dictionar/i,/handle/i,/reference/i,/identi/i,/extract/i,/index/i,/page/i,/command/i,/element/i,/vector/i |
| US2009070301 | U.S. Pat. No. 5,748,953 | 50.74627 | /search/i,/plurality/i,/keyword/i,/action/i,/document/i,/execut/i,/field/i,/match/i,/queries/i,/classification/i,/pattern/ |
| | | | i,/context/i,/user/i,/import/i,/frequency/i,/relevan/i,/pointer/i,/reference/i,/identi/i,/page/i,/command/i,/\btag/i,/element/i |
| U.S. Pat. No. 8,473,487 | U.S. Pat. No. 7,751,624 | 49.25373 | /search/i,/plurality/i,/action/i,/document/i,/execut/i,/field/i,/match/i,/queries/i,/pattern/i,/ |
| | | | context/i,/user/i,/collection/ |
| | | | i,/phrase/i,/ranking/i,/relevan/i,/reference/i,/identi/i,/metadata/i,/index/i,/page/i,/couple/i,/element/i |
| US2010287272 | U.S. Pat. No. 8,032,550 | 56.71642 | /search/i,/plurality/i,/keyword/i,/action/i,/document/i,/execut/i,/field/i,/hierarchica/i,/queries/i,/linked/i,/user/i,/ |
| | | | association/i,/collection/i,/phrase/i,/relevan/i,/reference/i,/identi/i,/extract/i,/index/i,/page/i,/co uple/i,/element/i,/array/i,/vector/i |
| U.S. Pat. No. 7,751,624 | US2006039610 | 57.21393 | /search/i,/plurality/i,/action/i,/document/i,/execut/i,/field/i,/match/i,/pattern/i,/context/i,/user/i,/adaptive/i,/association/ |
| | | | i,/import/i,/collection/i,/phrase/i,/relevan/i,/reference/i,/identi/i,/extract/i,/index/i,/page/i,/command/i,/couple/i,/element/i,/array/i |
| US2011019917 | US2006039610 | 57.21393 | /search/i,/action/i,/document/i,/execut/i,/field/i,/match/i,/pattern/i,/context/i,/user/i,/adaptive/i,/association/i,/import/ |
| | | | i,/collection/i,/phrase/i,/relevan/i,/reference/i,/identi/i,/extract/i,/index/i,/page/i,/command/i,/couple/i,/element/i,/array/i |
| U.S. Pat. No. 8,032,550 | US2010287272 | 57.21393 | /search/i,/plurality/i,/keyword/i,/action/i,/document/i,/execut/i,/field/i,/hierarchical/i,/queries/i,/linked/i,/user/i,/ |
| | | | adaptive/i,/association/i,/collection/i,/phrase/i,/relevan/i,/refereace/i,/identi/i,/extract/i,/index/i,/page/i,/couple/i,/ |
| | | | element/i,/array/i,/vector/i |
| US2006039610 | US2011019917 | 57.21393 | /search/i,/action/i,/document/i,/execut/i,/field/i,/match/i,/pattern/i,/context/i,/user/i,/adaptive/i,/association/i,/import/ |
| | | | i,/collection/i,/phrase/i,/relevan/i,/reference/i,/identi/i,/extract/i,/index/i,/page/i,/command/i,/couple/i,/element/i,/array/i |
| U.S. Pat. No. 8,407,232 | US2011082878 | 57.21393 | /search/i,/plurality/i,/keyword/i,/action/i,/attribute/i,/document/i,/execut/i,/field/i,/data\s*structure/i,/match/i,/queries/ |
| | | | i,/linkied/i,/user/i,/overlap/i,/association/i,/import/i,/frequency/i,/dictionar/i,/relevan/i,/reference/i,/identi/i,/extract/i,/index/i,/page/i,/element/i,/vector/i |
| US2008082505 | US2011082878 | 42.28856 | /search/i,/document/i,/execut/i,/field/i,/hierarchical/i,/queries/i,/user/i,/frequency/i,/dictionar/i,/ranking/i,/relevan/ |
| | | | i,/reference/i,/extract/i,/index/i,/element/i,/vector/i |
| US2006080295 | U.S. Pat. No. 8,577,865 | 51.24378 | /search/i,/action/i,/attribute/i,/document/i,/execut/i,/field/i,/match/i,/queries/i,/classification/i,/subset/i,/user/i,/association/ |
| | | | i,/reference/i,/identi/i,/metadata/i,/subroutine/i,/\btag/i,/couple/i,/element/i,/array/i |
| US2013124515 | US2003187834 | 53.23383 | /search/i,/plurality/i,/keyword/i,/action/i,/document/i,/execut/i,/field/i,/classification/i,/linked/i,/pattern/i,/context/ |
| | | | i,/user/i,/modify/i,/import/i,/frequency/i,/dictionar/i,/collection/i,/phrase/i,/relevan/i,/reference/i,/identi/i,/extract/i,/metadata/i,/page/i,/\btag/ |
| | | | i,/element/i,/vector/i |
| U.S. Pat. No. 7,047,255 | US2003220916 | 56.21891 | /search/i,/grouping/i,/plurality/i,/keyword/i,/action/i,/document/i,/field/i,/data\s*structure/i,/threshold/i,/hierarchical/ |
| | | | i,/user/i,/import/i,/frequency/i,/classify/i,/cluster/i,/relevan/i,/reference/i,/identi/i,/extract/i,/page/i,/command/i,/element/i,/vector/i |
| U.S. Pat. No. 7,185,001 | US2003220916 | 54.72637 | /search/i,/grouping/i,/plurality/i,/keyword/i,/action/i,/document/i,/field/i,/data\s*structure/i,/similarity\s*score/i,/ |
| | | | match/i,/threshold/i,/hierarchical/i,/queries/i,/classification/i,/user/i,/overlap/i,/association/i,/modify/i,/import/i,/ |
| | | | frequency/i,/collection/i,/phrase/i,/classify/i,/cluster/i,/ranking/i,/relevan/i,/reference/i,/identi/i,/extract/i,/index/i,/page/i,/\btag/i,/element/i,/vector/i |
| U.S. Pat. No. 7,836,391 | US2004255237 | 56.21891 | /search/i,/plurality/i,/action/i,/document/i,/execut/i,/field/i,/match/i,/threshold/i,/queries/i,/classification/i,/linked/i,/context/i,/ |
| | | | user/i,/import/i,/classify/i,/ranking/i,/relevan/i,/reference/i,/identi/i,/render/i,/index/i,/page/i,/couple/i,/element/i |
| US2011029518 | US2004255237 | 56.21891 | /search/i,/action/i,/document/i,/execut/i,/field/i,/match/i,/threshold/i,/queries/i,/classification/i,/linked/i,/context/ |
| | | | i,/user/i,/import/i,/classify/i,/ranking/i,/relevan/i,/reference/i,/identi/i,/render/i,/index/i,/page/i,/couple/i,/element/i |
| U.S. Pat. No. 9,189,548 | US2004255237 | 56.21891 | /search/i,/action/i,/document/i,/execut/i,/field/i,/match/i,/threshold/i,/queries/i,/classification/i,/linked/i,/context/ |
| | | | i,/user/i,/import/i,/classify/i,/ranking/i,/relevan/i,/reference/i,/identi/i,/render/i,/index/i,/page/i,/couple/i,/element/i |
| U.S. Pat. No. 5,748,953 | US2004267734 | 51.74129 | /search/i,/plurality/i,/action/i,/document/i,/execut/i,/field/i,/match/i,/threshold/i,/hierarchical/i,/queries/i,/pattern/i,/context/i,/user/i,/import/i,/frequency/i,/ |
| | | | dictionar/i,/relevan/i,/pointer/i,/reference/i,/identi,/extract/i,/index/i,/ |
| | | | page/i,/command/i,/element/i |
| US2015112693 | US2004267734 | 50.24876 | /search/i,/plurality/i,/keyword/i,/action/i,/document/i,/execut/i,/field/i,/data\s*structure/i,/match/i,/threshold/i,/hierarchical/i,/user/i,/ |
| | | | association/i,/import/i,/frequency/i,/handle/i,/reference/i,/identi/i,/extract/i,/index/i,/page/i,/vector/i |
| U.S. Pat. No. 6,473,754 | US2004267734 | 50.24876 | /search/i,/plurality/i,/keyword/i,/action/i,/document/i,/execut/i,/field/i,/threshold/i,/delimited/i,/user/i,/import/i,/ |
| | | | frequency/i,/dictionar/i,/ranking/i,/relevan/i,/reference/i,/identi/i,/extract/i,/index/i,/page/i,/command/i,/vector/i |
| U.S. Pat. No. 8,140,494 | US2009187797 | 54.72637 | /search/i,/keyword/i,/action/i,/document/i,/field/i,/match/i,/threshold/i,/classification/i,/subset/i,/context/i,/user/i,/import/i,/ |
| | | | collection/i,/phrase/i,/classify/i,/relevan/i,/reference/i,/identi/i,/extract/i,/metadata/i,/index/i,/page/i |
| US2004255237 | US2011029518 | 56.21891 | /search/i,/action/i,/document/i,/execut/i,/field/i,/match/i,/threshold/i,/queries/i,/classification/i,/linked/i,/context/ |
| | | | i,/user/i,/import/i,/classify/i,/ranking/i,/relevant/i,/reference/i,/identi/i,/render/i,/index/i,/page/i,/couple/i,/element/i |
| US2014006419 | US2014006390 | 56.21891 | /search/i,/keyword/i,/document/i,/execut/i,/field/i,/match/i,/context/i,/user/i,/frequency/i,/collection/i,/phrase/i,/ranking/i,/relevan/i,/reference/ |
| | | | i,/identi/i,/render/i,/metadata/i,/page/i,/command/i,/\btag/i,/couple/i,/element/i,/array/i |
| US2014006390 | US2014006419 | 56.21891 | /search/i,/keyword/i,/document/i,/execut/i,/field/i,/match/i,/context/i,/user/i,/frequency/i,/collection/i,/phsase/i,/ranking/i,/relevan/i,/reference/ |
| | | | i,/identi/i,/render/i,/metadata/i,/page/i,/command/i,/\btag/i,/couple/i,/element/i,/array/i |
| US2002041713 | U.S. Pat. No. 6,944,344 | 54.72637 | /search/i,/plurality/i,/keyword/i,/attribute/i,/document/i,/execut/i,/field/i,/match/i,/pattern/i,/user/i,/overlap/i,/modify |
| | | | i,/import/i,/dictionar/i,/phrase/i,/reference/i,/identi/i,/extract/i,/index/i,/page/i,/element/i,/vector/i |
| US2003220916 | U.S. Pat. No. 7,047,255 | 56.21891 | /search/i,/grouping/i,/plurality/i,/keyword/i,/action/i,/document/i,/field/i,/data\s*structure/i,/threshold/i,/hierarchical/i,/user/i,/import/i,/ |
| | | | frequency/i,/classify/i,/cluster/i,/relevan/i,/reference/i,/denti/i,/extract/i,/page/i,/command/i,/element/i,/vector/i |
| U.S. Pat. No. 5,832,476 | U.S. Pat. No. 7,054,854 | 45.77114 | /search/i,/plurality/i,/action/i,/document/i,/execut/i,/field/i,/classitication/i,/linked/i,/user/i,/classify/i,/indirect/i,/ |
| | | | reference/i,/identi/i,/extract/i,/page/i,/command/i,/\btag/i,/element/i |
| US2012110015 | U.S. Pat. No. 8,612,423 | 51.74129 | /search/i,/plurality/i,/keyword/i,/action/i,/document/i,/execut/i,/data\s*structure/i,/match/i,/queries/i,/subset/i,/user/i,/ |
| | | | modify/i,/refereace/i,/identi/i,/metadata/i,/index/i,/page/i,/command/i,/\btag/i,/element/i |
| U.S. Pat. No. 6,944,344 | US2002041713 | 55.22388 | /search/i,/plurality/i,/keyword/i,/action/i,/attribute/i,/document/i,/execut/i,/fieldl/i,/match/i,/pattern/i,/user/i,/overlap/i,/modify/i,/import/i,/dictionar/ |
| | | | i,/phrase/i,/reference/i,/identi/i,/extract/i,/index/i,/page/i,/element/i,/vector/i |
| US2017140037 | US2008077564 | 46.26866 | /search/i,/plurity/i,/keyword/i,/action/i,/attribute/i,/document/i,/execut/i,/field/i,/match/i,/user/i,/association/i,/ |
| | | | dictionar/i,/phrase/i,/handle/i,/refereace/i,/extract/i,/query\s*word/i,/page/i,\btag/i,/element/i |
| U.S. Pat. No. 8,117,194 | US2012221553 | 43.28358 | /search/i,/plurality/i,/action/i,/document/i,/execut/i,/data\s*structure/i,/querying/i,/linked/i,/context/i,/user/i,/cluster/i,/relevan/i,/reference/ |
| | | | i,/identi/i,/index/i,/page/i,/couple/i |
| US2017004186 | US2013117306 | 55.22388 | /search/i,/plurality/i,/action/i,/attribute/i,/document/i,/execut/i,/field/i,/match/i,/hierarchical/i,/linked/i,/delimited/i,/user/i,/association/i,/phrase/i,/ |
| | | | relevan/i,/reference/i,/identi/i,/index/i,/page/i,/\btag/i,/couple/i,/element/i |
| US2004249802 | US2013117306 | 47.76119 | /search/i,/grouping/i,/plurality/i,/document/i,/execut/i,/field/i,/match/i,/hierarchical/i,/linked/i,/delimited/i,/user/ |
| | | | i,/association/i,/dictionar/i,/phrase/i,/reference/i,/identi/i,/index/i,/page/i,/\btag/i |
| US2017132730 | US2015112693 | 49.25373 | /search/i,/plurality/i,/action/i,/document/i,/execut/i,/field/i,/data\s*structure/i,/match/i,/threshold/i,/linked/i,/context/i,/user/i,/association/i,/ |
| | | | import/i,/frequency/i,/phrase/i,/ranking/i,/indirect/i,/handle/i,/reference/i,/identi/i,/page/i,/couple/i,/element/i,/array/i,/vector/i |
| US2013117306 | US2017004186 | 55.22388 | /search/i,/plurality/i,/action/i,/attribute/i,/document/i,/execut/i,/field/i,/match/i,/hierarchical/i,/linked/i,/delimited/i,/user/i,/association/i,/phrase/i,/relevant/ |
| | | | i,/reference/i,/identi/i,/index/i,/page/i,/\btag/i,/couple/i,/element/i |
| US2010076999 | U.S. Pat. No. 6,470,336 | 49.25373 | /search/i,/plurality/i,/keyword/i,/action/i,/document/i,/field/i,/data\s*structure/i,/match/i,/threshold/i,/linked/i,/user/i,/association/i,/dictionar/i,/ |
| | | | phrase/i,/pointer/i,/reference/i,/identi/i,/extract/i,/index/i,/page/i,/element/i |
| US2004193584 | U.S. Pat. No. 6,473,754 | 44.77612 | /search/i,/plurality/i,/actiont/i,/document/i,/execut/i,/match/i,/threshold/i,/user/i,/modify/i,/ranking/i,/relevan/i,/reference/i,/extract/i,/index/i,/page/i,/ |
| | | | command/i,/vector/i |
| US2009055386 | U.S. Pat. No. 6,473,754 | 43.28358 | /search/i,/keyword/i,/document/i,/execut/i,/field/i,/regular\s*expression/i,/match/i,/threshold/i,/user/i,/import/i,/ |
| | | | dictionar/i,/collection/i,/ranking/i,/relevan/i,/reference/i,/identi/i,/command/i,/couple/i |
| US2003018629 | U.S. Pat. No. 7,349,899 | 50.74627 | /search/i,/action/i,/document/i,/execut/i,/field/i,/threshold/i,/hierarchical/i,/classification/i,/user/i,/association/i,/ |
| | | | import/i,/frequency/i,/classify/i,/cluster/i,/ranking/i,/reference/i,/identi/i,/extract/i,/index/i |
| US2003225755 | U.S. Pat. No. 7,349,899 | 47.76119 | /search/i,/plurality/i,/action/i,/document/i,/execut/i,/field/i,/hierarchical/i,/classification/i,/user/i,/association/i,/frequency/i,/collection/i,/classify/ |
| | | | i,/cluster/i,/relevan/i,/reference/i,/identi/i,/extract/i,/page/i,/element/i,/vector/i |
| US2009187797 | U.S. Pat. No. 8,140,494 | 55.22388 | /search/i,/keyword/i,/action/i,/document/i,/field/i,/match/i,/threshold/i,/classification/i,/subset/i,/context/i,/user/i,/import/i,/collection/i,/phrase/i,/ |
| | | | classify/i,/relevan/i,/reference/i,/identi/i,/extract/i,/aggregat/i,/metadata/i,/index/i,/page/i |
| U.S. Pat. No. 6,618,722 | U.S. Pat. No. 8,140,494 | 44.77612 | /search/i,/keyword/i,/action/i,/document/i,/field/i,/match/i,/threshold/i,/queries/i,/context/i,/user/i,/phrase/i,/relevan/i,/reference/i,/identi/ |
| | | | i,/extract/i,/page/i |
| US2012221553 | U.S. Pat. No. 8,473,487 | 47.76119 | /search/i,/plurality/i,/action/i,/document/i,/execut/i,/field/i,/queries/i,/relationships/i,/pattern/i,/context/i,/user/i,/ |
| | | | overlap/i,/import/i,/cluster/i,/relevan/i,/pointer/i,/reference/i,/identi/i,/metadata/i,index/i,/page/i,/couple/i |
| US2008076104 | U.S. Pat. No. 8,473,487 | 37.31343 | /search/i,/action/i,/document/i,/execut/i,/field/i,/context/i,/reference/i,/index/i,/couple/i,/element/i |
| US2010100544 | US2010010970 | 51.24378 | /search/i,/plurality/i,/action/i,/attribute/i,/document/i,/execut/i,/field/i,/data\s*structure/i,/match/i,/hierachical/i,/user/i,/import/i,/relevan/i,/handle/i,/ |
| | | | reference/i,/identi/i,/extract/i,/index/i,/\btag/i,/element/i |
| U.S. Pat. No. 6,470,336 | US2010076999 | 49.75124 | /search/i,/plurality/i,/keyword/i,/action/i,/document/i,/execut/i,/field/i,/data\s*structure/i,/match/i,/threshold/i,/user/i,/dictionar/i,/collection/i,/ |
| | | | phrase/i,/reference/i,/identi/i,/extract/i,/index/i,/page/i,/fingerprint/i,/element/i,/vector/i |
| U.S. Pat. No. 6,510,425 | U.S. Pat. No. 6,377,946 | 52.73632 | /search/i,/plurality/i,/attribute/i,/document/i,/execut/i,/field/i,/data\s*structure/i,/match/i,/hierarchical/i,/pattern/i,/context/i,/user/i,/pointer/i,/ |
| | | | reference/i,/identi/i,/extract/i,/index/i,/page/i,/command/i,/\btag/i,/element/i |
| U.S. Pat. No. 7,054,854 | U.S. Pat. No. 6,377,946 | 48.25871 | /search/i,/plurality/i,/keyword/i,/action/i,/attribute/i,/document/i,/execut/i,/field/i,/match/i,/hierarchical/i,/classification/i,/linked/i,/pattern/i,/ |
| | | | user/i,/phrase/i,/classify/i,/reference/i,/extract/i,/index/i,/page/i,/command/i,/\btag/i,/element/i |
| U.S. Pat. No. 6,377,946 | U.S. Pat. No. 6,510,425 | 52.73632 | /search/i,/plurality/i,/action/i,/attribute/i,/document/i,/execut/i,/field/i,/data\s*structure/i,/hierarchical/i,/pattern/i,/context/i,/user/i,/pointer/ |
| | | | i,/reference/i,/identi/i,/extract/i,/index/i,/page/i,/command/i,/\btag/i,/element/i |
| U.S. Pat. No. 5,628,008 | U.S. Pat. No. 6,510,425 | 48.25871 | /search/i,/plurality/i,/attribute/i,/document/i,/execut/i,/field/i,/data\s*structure/i,/match/i,/hierarchical/i,/relationships/i,/linked/i,/pattern/i,/context/i,/ |
| | | | user/i,/overlap/i,/modify/i,/relevan/i,/pointer/i,/reference/i,/identi/i,/extract/i,/page/i |
| US2003187649 | U.S. Pat. No. 7,089,188 | 46.76617 | /search/i,/document/i,/execut/i,/match/i,/queries/i,/user/i,/import/i,/frequency/i,/dictionar/i,/phrase/i,/ranking/i,/relevan/i,/reference/i,/query\s*word/i,/index/i,/ |
| | | | command/i |
| US2006230031 | U.S. Pat. No. 7,089,188 | 43.78109 | /search/i,/keyword/i,/action/i,/attribute/i,/document/i,/execut/i,/field/i,/match/i,/queries/i,/classification/i,/user/i,/import/i,/frequency/i,/phrase/i,/ranking/i,/ |
| | | | reference/i,/extract/i,/command/i |
| US2004068494 | U.S. Pat. No. 7,509,305 | 52.73632 | /search/i,/plurality/i,/action/i,/attribute/i,/document/i,/execut/i,/field/i,/data\s*structure/i,/match/i,/hierarchical/i,/pattern/i,/ |
| | | | import/i,/collection/i,/classify/i,/reference/i,/identi/i,/page/i,/\btag/i,/couple/i,/element/i |
| US2008208843 | U.S. Pat. No. 8,086,561 | 52.73632 | /search/i,/plurality/i,/attribute/i,/document/i,/execut/i,/field/i,/data\s*structure/i,/match/i,/hierarchical/i,/queries/ |
| | | | i,/relationships/i,/subset/i,/user/i,/modify/i,/reference/i,/identi/i,/extract/i,/index/i,/\btag/i,/element/i |
| US2008077564 | U.S. Pat. No. 8,086,561 | 49.75124 | /search/i,/plurality/i,/keyword/i,/action/i,/attribute/i,/document/i,/execut/i,/field/i,/data\s*structure/i,/match/i,/hierarchical/i,/queries/i,/ |
| | | | relationships/i,/user/i,/handle/i,/reference/i,/identi/i,/extract/i,/render/i,/page/i,/\btag/i,/element/i |
| US2010228743 | U.S. Pat. No. 9,098,570 | 48.25871 | /search/i,/plurality/i,/document/i,/execut/i,/field/i,/match/i,/queries/i,/classification/i,/subset/i,/context/i,/user/i,/modify/i,/frequency/i,/collection/i,/ |
| | | | ranking/i,/relevan/i,/reference/i,/identi/i,/extract/i,/aggregat/i,/page/i,/vector/i |
| US2013318120 | U.S. Pat. No. 9,384,304 | 52.73632 | /search/i,/plurality/i,/action/i,/document/i,/execut/i,/field/i,/data\s*structure/i,/match/i,/threshold/i,/queries/i,/pattern/i,/context/i,/user/i,/overlap/i,/modify/i,/ |
| | | | indirect/i,/reference/i,/extract/i,/page/i,/vector/i |
| U.S. Pat. No. 7,509,305 | US2004068494 | 53.23383 | /search/i,/plurality/i,/action/i,/attribute/i,/document/i,/execut/i,/field/i,/data\s*structure/i,/match/i,/hierarchical/i,/pattern/i,/import/i,/collection/ |
| | | | i,/classify/i,/reference/i,/identi/i,/index/i,/page/i,/\btag/i,/couple/i,/element/i |
| U.S. Pat. No. 8,577,865 | US2006080295 | 53.23383 | /search/i,/action/i,/attribute/i,/document/i,/execut/i,/field/i,/match/i,/queries/i,/classification/i,/subset/i,/pattern/i,/user/i,/adaptive/i,/association/i,/ |
| | | | cluster/i,/reference/i,/identi/i,/metadata/i,/page/i,/subroutine/i,/\btag/i,/couple/i,/element/i,/array/i |
| U.S. Pat. No. 8,086,561 | US2008208843 | 53.23383 | /search/i,/plurality/i,/attribute/i,/document/i,/execut/i,/field/i,/data\s*structure/i,/match/i,/hierarchical/i,/queries/i,/relationships/i,/subset/i,/user/i,/ |
| | | | modify/i,/reference/i,/identi/i,/extract/i,/index/i,/page/i,/\btag/i,/element/i |
| US2010010970 | US2010100544 | 51.74129 | /search/i,/plurality/i,/action/i,/attribute/i,/document/i,/execut/i,/field/i,/data\s*structure/i,/hierarchical/i,/user/i,/import/i,/relevan/i,/handle/i,/reference/i,/identi/ |
| | | | i,/extract/i,/metadata/i,/index/i,/command/i,/\btag/i,/element/i |
| U.S. Pat. No. 8,612,423 | US2012110015 | 53.23383 | /search/i,/plurality/i,/keyword/i,/action/i,/document/i,/execut/i,/field/i,/data\s*structure/i,/match/i,/queries/i,/subset/i,/user/i,/adaptive/i,/modify/i,/ |
| | | | reference/i,/identi/i,/metadata/i,/index/i,/page/i,/command/i,/\btag/i,/couple/i,/element/i |
| U.S. Pat. No. 9,384,304 | US2013318120 | 53.23383 | /search/i,/plurality/i,/action/i,/document/i,/execut/i,/field/i,/data\s*structure/i,/match/i,/threshold/i,/queries/i,/pattern/i,/context/i,/user/i,/overlap/i,/ |
| | | | modify/i,/indirect/i,/reference/i,/identi/i,/extract/i,/page/i,/vector/i |
| U.S. Pat. No. 8,600,972 | U.S. Pat. No. 8,145,654 | 53.23383 | /search/i,/plurality/i,/keyword/i,/action/i,/document/i,/execut/i,/field/i,/match/i,/user/i,/import/i,/frequency/i,/collection/i,/phrase/i,/relevan/i,/ |
| | | | reference/i,/identi/i,/index/i,/page/i,/\btag/i,/element/i |
| US2010049705 | U.S. Pat. No. 8,145,654 | 50.24876 | /search/i,/plurality/i,/keyword/i,/action/i,/document/i,/field/i,/data\s*structure/i,/match/i,/context/i,/user/i,/association/i,/import/i,/frequency/i,/ |
| | | | dictionar/i,/collection/i,/phrase/i,/relevan/i,/reference/i,/identi/i,/extract/i,/render/i,/index/i,/\btag/i,/element/i |
| U.S. Pat. No. 8,145,654 | U.S. Pat. No. 8,600,972 | 53.23383 | /search/i,/plurality/i,/keyword/i,/action/i,/document/i,/execut/i,/field/i,/match/i,/user/i,/import/i,/frequency/i,/collection/i,/phrase/i,/relevan/ |
| | | | i,/reference/i,/identi/i,/index/i,/page/i,/\btag/i,/element/i |
| U.S. Pat. No. 7,349,899 | US2003018629 | 52.23881 | /search/i,/keyword/i,/action/i,/document/i,/execut/i,/field/i,/threshold/i,/hierarchical/i,/classification/i,/user/i,/association/i,/import/i,/frequency/i,/ |
| | | | collection/i,/classify/i,/cluster/i,/ranking/i,/reference/i,/identi/i,/extract/i,/index/i,/page/i |
| U.S. Pat. No. 7,966,307 | US2008306919 | 52.23881 | /search/i,/keyword/i,/document/i,/execut/i,/field/i,/match/i,/threshold/i,/queries/i,/pattern/i,/user/i,/modify/i,/relevan/i,/reference/i,/identi/i,/extract/ |
| | | | i,/index/i,/page/i,/element/i,/array/i |
| U.S. Pat. No. 9,098,570 | US2012254161 | 52.23881 | /search/i,/plurality/i,/document/i,/execut/i,/field/i,/match/i,/queries/i,/subset/i,/context/i,/user/i,/import/i,/frequency/i,/collection/i,/phrase/i,/relevan/ |
| | | | i,/reference/i,/identi/i,/extract/i,/render/i,/index/i,/page/i |
| US2015294017 | US2012254161 | 52.23881 | /search/i,/plurality/i,/document/i,/execut/i,/field/i,/match/i,/queries/i,/subset/i,/context/i,/user/i,/import/i,/frequeacy/i,/collection/i,/phrase/i,/relevan/i,/ |
| | | | reference/i,/extract/i,/render/i,/index/i |
| US2012254161 | US2015294017 | 52.23881 | /search/i,/plurality/i,/document/i,/execut/i,/field/i,/match/i,/queries/i,/subset/i,/context/i,/user/i,/import/i,/frequency/i,/collection/i,/phrase/i,/relevan/i,/ |
| | | | reference/i,/extract/i,/render/i,/index/i |
| U.S. Pat. No. 7,174,290 | U.S. Pat. No. 6,654,717 | 52.23881 | /search/i,/plurality/i,/document/i,/execut/i,/field/i,/match/i,/queries/i,/context/i,/user/i,/frequency/i,/dictionar/i,/collection/i,/ranking/i,/relevan/ |
| | | | i,/refereace/i,/identi/i,/index/i,/page/i,/couple/i |
| US2001007987 | U.S. Pat. No. 6,853,992 | 50.74627 | /search/i,/plurality/i,/keyword/i,/document/i,/field/i,/match/i,/hierarchical/i,/relationships/i,/linked/i,/user/i,/pointer/i,/reference/i,/identi/i,/extract/i,/ |
| | | | render/i,/index/i,/\btag/i,/element/i |
| U.S. Pat. No. 6,654,717 | U.S. Pat. No. 7,174,290 | 52.23881 | /search/i,/plurality/i,/document/i,/execut/i,/field/i,/match/i,/queries/i,/context/i,/user/i,/frequency/i,/dictionar/i,/collection/i,/ranking/i,/relevan/ |
| | | | i,/reference/i,/identi/i,/index/i,/page/i,/couple/i |
| US2008306919 | U.S. Pat. No. 7,966,307 | 52.23881 | /search/i,/keyword/i,/document/i,/execut/i,/field/i,/match/i,/threshold/i,/queries/i,/pattern/i,/user/i,/modify/i,/relevan/i,/reference/i,/identi/i,/extract/i,/ |
| | | | index/i,/page/i,/element/i,/array/i |
| US2009019010 | U.S. Pat. No. 8,429,154 | 49.25373 | /search/i,/plurality/i,/action/i,/document/i,/execut/i,/field/i,/match/i,/threshold/i,/document\s*of\s*interest/i,/user/i,/import/i,/ranking/i,/ |
| | | | reference/i,/identi/i,/extract/i,/page/i,/\btag/i |
| U.S. Pat. No. 6,853,992 | US2001007987 | 51.24378 | /search/i,/plurality/i,/keyword/i,/document/i,/field/i,/match/i,/hierarchical/i,/relationships/i,/linked/i,/user/i,/pointer/i,/reference/i,/identi/i,/extract/i,/ |
| | | | render/i,/index/i,/page/i,/\btag/i,/element/i |
| US2004006456 | US2002161570 | 51.24378 | /search/i,/plurality/i,/document/i,/execut/i,/field/i,/match/i,/queries/i,/context/i,/user/i,/frequency/i,/dictionar/i,/collection/i,/relevan/i,/reference/i,/identi/i,/ |
| | | | index/i,/page/i,/couple/i |
| US2007106500 | US2002161570 | 51.24378 | /search/i,/plurality/i,/document/i,/execut/i,/field/i,/match/i,/queries/i,/context/i,/user/i,/frequency/i,/dictionar/i,/collection/i,/relevan/i,/reference/i,/identi/i,/ |
| | | | index/i,/page/i,/couple/i |
| U.S. Pat. No. 6,466,901 | US2002161570 | 51.24378 | /search/i,/plurality/i,/document/i,/execut/i,/field/i,/match/i,/queries/i,/context/i,/user/i,/frequency/i,/dictionar/i,/collection/i,/relevan/i,/reference/i,/ |
| | | | identi/i,/index/i,/page/i,/couple/i |
| U.S. Pat. No. 7,369,987 | US2002161570 | 51.24378 | /search/i,/plurality/i,/document/i,/execut/i,/field/i,/match/i,/queries/i,/context/i,/user/i,/frequency/i,/dictionar/i,/collection/i,/relevan/i,/reference/i,/ |
| | | | identi/i,/index/i,/page/i,/couple/i |
| US2002161570 | US2004006456 | 51.24378 | /search/i,/plurality/i,/document/i,/execut/i,/field/i,/match/i,/queries/i,/context/i,/user/i,/frequency/i,/dictionar/i,/collection/i,/relevan/i,/reference/i,/identi/i,/ |
| | | | index/i,/page/i,/couple/i |
| U.S. Pat. No. 7,401,078 | US2006031211 | 51.24378 | /search/i,/plurality/i,/keyword/i,/attribute/i,/document/i,/execut/i,/field/i,/user/i,/association/i,/ranking/i,/relevan/i,/reference/i,/identi/i,/extract/i,/ |
| | | | index/i,/page/i,/\btag/i,/element/i |
| US2009183115 | US2006031211 | 45.27363 | /search/i,/grouping/i,/plurality/i,/keyword/i,/attribute/i,/document/i,/execut/i,/field/i,/match/i,/relationships/i,/user i,/frequency/i,/relevan/i,/reference/i,/ |
| | | | identi/i,/extract/i,/page/i,/element/i |
| US2012023133 | US2006031211 | 45.27363 | /search/i,/plurality/i,/keyword/i,/document/i,/execut/i,/field/i,/linked/i,/user/i,/dictionar/i,/handle/i,/reference/i,/identi/i,/extract/i,/metadata/i,/index/i,/page/ |
| | | | i,/\btag/i,/element/i |
| U.S. Pat. No. 6,298,344 | US2006031211 | 43.78109 | /search/i,/plurality/i,/keyword/i,/document/i,/execut/i,/field/i,/match/i,/user/i,/ranking/i,/reference/i,/identi/i,/index/i,/page/i,/command/i,/element/i |
| US2014063564 | US2007083508 | 42.28856 | /search/i,/plurality/i,/keyword/i,/action/i,/document/i,/execut/i,/pattern/i,/user/i,/overlap/i,/reference/i,/identi/i,/extract/i,/page/i |
| US2012150866 | US2009319510 | 51.24378 | /search/i,/plurality/i,/keyword/i,/document/i,/execut/i,/field/i,/user/i,/import/i,/frequency/i,/collection/i,/phrase/i,/relevan/i,/reference/i,/identi/i,/index/i,/page/ |
| | | | i,/\btag/i,/element/i |
| US2009319510 | US2012150866 | 51.24378 | /search/i,/plurality/i,/keyword/i,/document/i,/execut/i,/field/i,/user/i,/import/i,/frequency/i,/colliection/i,/phrase/i,/relevan/i,/reference/i,/identi/i,/index/i,/page/ |
| | | | i,/\btag/i,/element/i |
| US2002095404 | U.S. Pat. No. 6,718,323 | 46.76617 | /search/i,/document/i,/field/i,/match/i,/threshold/i,/user/i,/overlap/i,/import/i,/frequency/i,/phrase/i,/ranking/i,/relevan/i,/identi/i,/index/i,/element/i |
| US2006031211 | U.S. Pat. No. 7,401,078 | 51.24378 | /search/i,/plurality/i,/keyword/i,/attribute/i,/document/i,/execut/i,/field/i,/user/i,/association/i,/ranking/i,/relevan/i,/reference/i,/identi/i,/extract/i,/ |
| | | | index/i,/page/i,/\btag/i,/element/i |
| US2009119343 | U.S. Pat. No. 7,937,389 | 49.75124 | /search/i,/plurality/i,/document/i,/execut/i,/field/i,/data\s*structure/i,/threshold/i,/fiequency/i,/dictionar/i,/collection/i,/cluster/i,/relevan/i,/ |
| | | | reference/i,/index/i,/page/i,/element/i,/vector/i |
| US2008222141 | US2008222112 | 48.75622 | /search/i,/plurality/i,/document/i,/execut/i,/field/i,/hierarchical/i,/queries/i,/context/i,/user/i,/phrase/i,/classify/i,/relevan/i,/reference/i,/identi/i,/\btag/ |
| | | | i,/couple/i,/element/i |
| US2008222112 | US2008222141 | 48.75622 | /search/i,/grouping/i,/plurality/i,/document/i,/execut/i,/field/i,/hierarchical/i,/queries/i,/context/i,/user/i,/phrase/i,/relevan/i,/reference/i,/identi/i,/\btag/ |
| | | | i,/couple/i,/element/i |
| U.S. Pat. No. 8,429,154 | US2009019010 | 50.24876 | /search/i,/plurality/i,/action/i,/document/i,/execut/i,/field/i,/match/i,/threshold/i,/relationships/i,/document\s*of\s*interest/i,/user/i,/import/ |
| | | | i,/frequency/i,/ranking/i,/reference/i,/identi/i,/extract/i,/page/i,/\btag/i |
| US2013226917 | US2009019010 | 48.75622 | /search/i,/action/i,/document/i,/execut/i,/field/i,/match/i,/threshold/i,/document\s*of\s*interest/i,/user/i,/import/i,/ranking/i,/refereace/i,/identi/ |
| | | | i,/extract/i,/render/i,/page/i,/\btag/i |
| U.S. Pat. No. 7,937,389 | US2009119343 | 50.24876 | /search/i,/plurality/i,/document/i,/execut/i,/field/i,/data\s*structure/i,/threshold/i,/frequency/i,/dictionar/i,/collection/i,/cluster/i,/relevan/i,/ |
| | | | reference/i,/identi/i,/index/i,/page/i,/element/i,/vector/i |
| US2005210007 | U.S. Pat. No. 7,324,998 | 48.75622 | /search/i,/plurality/i,/attribute/i,/document/i,/execut/i,/match/i,/hierarchical/i,/subset/i,/context/i,/user/i,/relevan/i,/indirect/i,/reference/i,/identi/i,/ |
| | | | page/i,/couple/i |
| US2004015779 | U.S. Pat. No. 7,324,998 | 38.30846 | /search/i,/attribute/i,/document/i,/field/i,/user/i,/frequency/i,/relevan/i,/identi/i,/page/i,/couple/i |
| U.S. Pat. No. 7,089,188 | US2003187649 | 49.25373 | /search/i,/document/i,/execut/i,/field/i,/match/i,/queries/i,/classification/i,/user/i,/import/i,/frequency/i,/dictionar/i,/phrase/i,/cluster/i,/ranking/i,/ |
| | | | relevan/i,/reference/i,/identi/i,/query\s*word/i,/indexi/i,/page/i,/command/i |
| U.S. Pat. No. 7,324,998 | US2005210007 | 49.25373 | /search/i,/plurality/i,/attribute/i,/document/i,/execut/i,/field/i,/match/i,/hierarchical/i,/subset/i,/context/i,/user/i,/relevan/i,/indirect/i,/reference/i,/ |
| | | | identi/i,/page/i,/couple/i |
| U.S. Pat. No. 7,240,051 | US2008016065 | 46.26866 | /search/i,/plurality/i,/keyword/i,/document/i,/field/i,/match/i,/linked/i,/user/i,/association/i,/import/i,/dictionar/i,/relevan/i,/reference/i,/identi/i,/ |
| | | | extract/i,/page/i |
| US2012239654 | US2008016065 | 44.77612 | /search/i,/plurality/i,/keyword/i,/document/i,/execut/i,/field/i,/threshold/i,/classification/i,/linked/i,/user/i,/association/i,/import/i,/collection/i,/relevan/i,/ |
| | | | indirect/i,/reference/i,/extract/i,/page/i,/vector/i |
| US2008016065 | U.S. Pat. No. 7,240,051 | 46.26866 | /search/i,/plurality/i,/keyword/i,/document/i,/execut/i,/field/i,/match/i,/association/i,/import/i,/dictionar/i,/relevan/i,/reference/i,/identi/i,/extract/ |
| | | | i,/page/i,/vector/i |
| US2004181520 | U.S. Pat. No. 7,240,051 | 44.77612 | /search/i,/keyword/i,/document/i,/field/i,/match/i,/user/i,/association/i,/import/i,/dictionar/i,/relevan/i,/reference/i,/identi/i,/page/i |
| U.S. Pat. No. 6,718,323 | US2002095404 | 48.25871 | /search/i,/plurality/i,/document/i,/field/i,/match/i,/threshold/i,/user/i,/overlap/i,/import/i,/frequency/i,/phrase/i,/ranking/i,/relevan/i,/reference/ |
| | | | i,/identi/i,/index/i,/page/i,/element/i |
| US2017046446 | US2006069670 | 48.25871 | /search/i,/plurality/i,/action/i,/document/i,/execut/i,/field/i,/queries/i,/linked/i,/user/i,/phrase/i,/relevan/i,/reference/i,/identi/i,/index/i,/page/i,/element/i,/ |
| US2013185287 | US2006069670 | 48.25871 | /search/i,/plurality/i,/document/i,/execut/i,/field/i,/queries/i,/linked/i,/user/i,/phrase/i,/relevan/i,/reference/i,/identi/i,/index/i,/page/i,/element/i |
| U.S. Pat. No. 8,364,668 | US2006069670 | 48.25871 | /search/i,/plurality/i,/document/i,/execut/i,/field/i,/queries/i,/linked/i,/user/i,/phrase/i,/relevan/i,/reference/i,/identi/i,/index/i,/page/i,/element/i |
| U.S. Pat. No. 9,483,534 | US2006069670 | 46.76617 | /search/i,/document/i,/execut/i,/field/i,/queries/i,/linked/i,/user/i,/phrase/i,/relevan/i,/reference/i,/identi/i,/index/i,/page/i,/element/i |
| U.S. Pat. No. 7,979,438 | US2006206527 | 48.25871 | /search/i,/plurality/i,/document/i,/field/i,/match/i,/threshold/i,/association/i,/frequency/i,/dictionar/i,/reference/i,/identi/i,/extract/i,/index/i,/page/i,/array/i |
| US2006069670 | US2013185287 | 48.25871 | /search/i,/plurality/i,/document/i,/execut/i,/field/i,/queries/i,/linked/i,/user/i,/phrase/i,/relevan/i,/reference/i,/identi/i,/index/i,/page/i,/element/i |
| US2011167062 | U.S. Pat. No. 6,298,344 | 42.28856 | /search/i,/plurality/i,/keyword/i,/document/i,/execut/i,/field/i,/user/i,/relevan/i,/reference/i,/index/i,/page/i,/command/i |
| US2006206527 | U.S. Pat. No. 7,979,438 | 48.25871 | /search/i,/plurality/i,/document/i,/field/i,/match/i,/threshold/i,/association/i,/frequency/i,/dictionar/i,/reference/i,/identi/i,/extract/i,/index/i,/page/i,/array/i |
| US2013301921 | U.S. Pat. No. 8,938,123 | 45.27363 | /search/i,/plurality/i,/document/i,/execut/i,/field/i,/match/i,/delimited/i,/user/i,/overlap/i,/handle/i,/reference/i,/page/i,/vector/i |
| U.S. Pat. No. 9,020,267 | US2014072225 | 47.26368 | /search/i,/plurality/i,/document/i,/execut/i,/field/i,/threshold/i,/pattern/i,/user/i,/overlap/i,/dictionar/i,/handle/i,/reference/i,/identi/i,/page/i |
| U.S. Pat. No. 8,775,455 | US2014229505 | 47.26368 | /search/i,/plurality/i,/keyword/i,/document/i,/execut/i,/field/i,/user/i,/import/i,/phrase/i,/relevan/i,/reference/i,/identi/i,/extract/i,/page/i |
| U.S. Pat. No. 9,298,710 | US2014229505 | 47.26368 | /search/i,/plurality/i,/keyword/i,/document/i,/execut/i,/field/i,/user/i,/import/i,/phrase/i,/relevan/i,/reference/i,/identi/i,/extraci/i,/page/i |
| US2010196295 | US2014229505 | 45.77114 | /search/i,/plurality/i,/keyword/i,/document/i,/execut/i,/field/i,/user/i,/import/i,/phrase/i,/relevan/i,/identi/i,/extract/i,/page/i |
| US2015095314 | US2014229505 | 42.78607 | /search/i,/plurality/i,/document/i,/execut/i,/field/i,/threshold/i,/user/i,/phrase/i,/cluster/i,/reference/i,/identi/i,/extract/i,/page/i,/element/i |
| U.S. Pat. No. 9,697,422 | US2015347835 | 47.26368 | /search/i,/document/i,/execut/i,/field/i,/data\s*structure/i,/match/i,/threshold/i,/user/i,/adaptive/i,/handle/i,/reference/i,/identi/i,/index/i,/page/i |
| U.S. Pat. No. 6,212,537 | U.S. Pat. No. 5,956,740 | 47.26368 | /search/i,/keyword/i,/document/i,/execut/i,/field/i,/linked/i,/context/i,/dictionar/i,/reference/i,/identi/i,/page/i,/command/i,/\btag/i,/element/i |
| U.S. Pat. No. 5,956,740 | U.S. Pat. No. 6,212,537 | 47.26368 | /search/i,/keyword/i,/document/i,/execut/i,/field/i,/linked/i,/context/i,/dictionar/i,/reference/i,/identi/i,/page/i,/command/i,/\btag/i,/element/i |
| US2014229505 | U.S. Pat. No. 8,775,455 | 47.26368 | /search/i,/plurality/i,/keyword/i,/document/i,/execut/i,/field/i,/user/i,/import/i,/phrase/i,/relevan/i,/reference/i,/identi/i,/extract/i,/page/i |
| US2014072225 | U.S. Pat. No. 9,020,267 | 47.26368 | /search/i,/plurality/i,/document/i,/execut/i,/field/i,/threshold/i,/pattern/i,/user/i,/overlap/i,/dictionar/i,/handle/i,/reference/i,/identi/i,/page/i |
| US2005256868 | U.S. Pat. No. 9,483,534 | 44.27861 | /search/i,/document/i,/execut/i,/linked/i,/pattern/i,/user/i,/import/i,/phrase/i,/relevan/i,/reference/i,/identi/i,/index/i,/page/i,/command/i,/element/i |
| US2015347835 | U.S. Pat. No. 9,697,422 | 47.26368 | /search/i,/document/i,/execut/i,/field/i,/data\s*structure/i,/match/i,/threshold/i,/user/i,/adaptive/i,/handle/i,/reference/i,/identi/i,/index/i,/page/i |
| U.S. Pat. No. 6,356,894 | US2001016860 | 46.26866 | /search/i,/document/i,/execut/i,/field/i,/linked/i,/context/i,/dictionar/i,/reference/i,/identi/i,/page/i,/command/i,/\btag/i,/element/i |
| U.S. Pat. No. 8,938,123 | US2013301921 | 46.26866 | /search/i,/plurality/i,/action/i,/document/i,/execut/i,/field/i,/match/i,/delimited/i,/user/i,/overlap/i,/handle/i,/reference/i,/identi/i,/page/i,/vector/i |
| US2007083508 | US2014063564 | 44.77612 | /search/i,/plurality/i,/keyword/i,/action/i,/document/i,/execut/i,/field/i,/data\s*structure/i,/document\s*of\s*interest/i,/pattern/i,/user/i,/indirect/i,/ |
| | | | reference/i,/identi/i,/extract/i,/page/i,/command/i,/couple/i |
| US2001016860 | U.S. Pat. No. 6,356,894 | 46.26866 | /search/i,/document/i,/execut/i,/field/i,/linked/i,/context/i,/dictionar/i,/reference/i,/identi/i,/page/i,/command/i,/\btag/i,/element/i |
| US2007234238 | US2006206829 | 45.27363 | /search/i,/plurality/i,/document/i,/execut/i,/field/i,/user/i,/pointer/i,/refereace/i,/identi/i,/extract/i,/index/i,/page/i |
| US2006206829 | US2007234238 | 45.27363 | /search/i,/plurality/i,/document/i,/execut/i,/field/i,/user/i,/pointer/i,/reference/i,/identi/i,/extract/i,/index/i,/page/i |

²Clustered matches of 3 or more documents are shown in bold font

I claim:

1. A method for search and grouping of documents comprising the steps of:
a. Providing a plurality of keywords
b. Incorporating each keyword in a data structure, such that the keyword is operably linked to at least one field specifying an action to be taken on encountering a match and at least one field containing a document attribute, which may be set or changed on encountering a match
c. Searching a plurality of documents with all of the keywords
d. On encountering a match, executing the action(s) specified in the one or more action fields
e. Changing the content of the one or more attribute fields as specified by the action field(s)
f. Extracting result data from said plurality of data structures containing the keywords, and
g. Displaying the data to the user.

2. The method of claim 1 comprising the further steps of
a. For each document, storing the document file name or link thereto, together with an array of matching keywords extracted from the data structures according to the methods of claim 1
b. For the plurality of documents, computing successive pairwise similarity scores for each keyword set from claim 2(a) with all of the others
c. Storing the highest si a score and its document file name (the “target document file name”) such that it is operably linked to the document data of Step 2(a)
d. Sorting the stored data from Step 2(c) first by target document file name and second by similarity score
e. Displaying the sorted data to the user.

3. The method of claim 1 where the keywords are formulated as regular expressions

4. The method of claim 1 where the data structure is a data object

5. The method of claim 1 where the action is selected from the group comprising
a. Return the line of text surrounding the match and append it to a document attribute field in the keyword data structure
b. For page-based searches, append the page number where the match is found to a document attribute field in the keyword data structure
c. For document-based searches, change a document attribute field in the keyword data structure from False to True, or increment a counter and enter the result in a document attribute field in the keyword data structure
d. For metadata searches, append the requested metadata to a document attribute field in the keyword data structure

6. The method of claim 1 where the number of matching keywords is compared with a user-defined threshold and only results exceeding the threshold are displayed

7. The method of claim 2 where the similarity score is computed using the following expression:
Simscore=100*(n+(2h−m))/3n
where n is the total number of keywords, h is the number of pairwise matches, m is the sum total of mismatches in both directions, i.e. query to target plus target to query

8. An apparatus comprising one or more computers programmed to carry out the methods of this invention

9. A set of one or more data structures composed using the methods of claim 1

10. A data structure prepared according to the method of claim 1, where the keywords are selected from at least 2 distinct contextual areas, and the results are sorted according to the method of claim 2 such that contextually overlapping documents may be identified.
